(19) United States
(12) Patent Application Publication
(10) Pub. No.: US 2013/0021318 A1
(43) Pub. Date: Jan. 24, 2013

(54) METHOD FOR DRIVING PLASMA DISPLAY PANEL AND PLASMA DISPLAY DEVICE

(71) Applicants: Yutaka Yoshihama, Osaka (JP); Kazuki Sawa, Osaka (JP)

(72) Inventors: Yutaka Yoshihama, Osaka (JP); Kazuki Sawa, Osaka (JP)

(73) Assignee: PANASONIC CORPORATION, Osaka (JP)

(21) Appl. No.: 13/639,009

(22) PCT Filed: May 27, 2011
(86) PCT No.: PCT/JP2011/002960

§ 371 Date: Oct. 2, 2012

(30) Foreign Application Priority Data
May 27, 2010 (JP) 2010-121098

(51) Int. Cl. G06F 3/038

(52) U.S. Cl. 345/212

(57) ABSTRACT

In display of an image on a plasma display panel, the contrast of the display image is enhanced. For this purpose, the voltage obtained by subtracting the voltage applied to the data electrode from the low-side voltage of the sustain pulses applied to the scan electrode in the sustain period is defined as a first voltage. The voltage obtained by subtracting the voltage applied to the data electrode from the high-side voltage of the sustain pulses applied to the scan electrode is defined as a second voltage. The voltage obtained by subtracting the low-side voltage of the address pulse applied to the data electrode from the low-side voltage of the scan pulse applied to the scan electrode in the address period is defined as a third voltage. Based on these definitions, the voltage applied to each electrode is set so as to satisfy the conditions that: the voltage obtained by subtracting the third voltage from the first voltage is equal to or higher than the discharge start voltage between the data electrode as an anode and the scan electrode as a cathode; and the voltage obtained by subtracting the third voltage from the second voltage is equal to or lower than the sum of the discharge start voltage between the data electrode as an anode and the scan electrode as a cathode and the discharge start voltage between the data electrode as a cathode and the scan electrode as an anode.

### TECHNICAL FIELD

The present invention relates to a driving method for a plasma display panel of the AC surface discharge type, and to a plasma display apparatus.

### BACKGROUND ART

In an AC surface discharge panel, i.e. a typical plasma display panel (hereinafter, simply referred to as “panel”), a large number of discharge cells are formed between a front substrate and a rear substrate facing each other. With the front substrate, a plurality of display electrode pairs, each including a scan electrode and a sustain electrode, is formed in parallel with each other on a front glass substrate. A dielectric layer and a protective layer are formed so as to cover these display electrode pairs.

With the rear substrate, a plurality of parallel data electrodes is formed on a rear glass substrate. A dielectric layer is formed so as to cover these data electrodes. On the dielectric layer, a plurality of barrier ribs is formed in parallel with the data electrodes. Phosphor layers are formed on the surface of the dielectric layer and on the side faces of the barrier ribs.

The front substrate and the rear substrate are opposed to each other and sealed together such that the display electrode pairs three-dimensionally intersect the data electrodes. The sealed inside discharge space is filled with a discharge gas containing xenon at a partial pressure ratio of 5%, for example, and discharge cells are formed in the parts where the display electrode pairs face the data electrodes. In the respective discharge cells of the thus structured panel, a gas discharge generates ultraviolet rays, and the ultraviolet rays excite the phosphors of red color (R), green color (C), and blue color (B) such that the phosphors of the respective colors emit light for color image display.

A typically used method for driving the panel is a subfield method. In the subfield method, gradations are displayed by dividing one field into a plurality of subfields and causing light emission or no light emission in each discharge cell in each subfield. Each subfield has an initializing period, an address period, and a sustain period.

In the initializing periods, an initializing operation is performed in the following manner. Initializing waveforms are applied to the respective scan electrodes so as to cause an initializing discharge in the respective discharge cells. This operation forms wall charge necessary for the succeeding address operation in the respective discharge cells, and generates priming particles (excitation particles for generating a discharge) for generating a stable address discharge.

The initializing operation includes the following two types: a forced initializing operation for causing an initializing discharge in the respective discharge cells regardless of the operation in the immediately preceding subfield; and a selective initializing operation for causing an initializing discharge only in the discharge cells having undergone an address discharge in the immediately preceding subfield.

In the address periods, an address operation is performed so as to cause an address discharge and form wall charge selectively in discharge cells in response to an image to be displayed. In the address periods, a scan pulse is applied sequentially to the scan electrodes, and an address pulse is applied selectively to the data electrodes in response to the signals of an image to be displayed. This operation causes an address discharge between the scan electrodes and the data electrodes in the discharge cells to be lit and forms wall charge in the discharge cells.

In the sustain periods, a sustain operation is performed in the following manner. A number of sustain pulses based on the luminance weight predetermined for each subfield are applied alternately to the display electrode pairs, each including a scan electrode and a sustain electrode. Thereby, a sustain discharge occurs in the discharge cells having undergone the address discharge, and the phosphor layers of the discharge cells emit light. (Hereinafter, causing a discharge cell to be lit by a sustain discharge is also referred to as “lighting”, and causing a discharge cell not to be lit as “non-lighting”. ) Thus, the respective discharge cells are lit at luminances corresponding to the luminance weight. The light emission caused by this sustain discharge is a light emission related to gradation display. The other light emissions are those unrelated to gradation display. An example of the other light emissions is the light emission caused by a forced initializing operation.

In this manner, the respective discharge cells of the panel are lit at luminances corresponding to the gradation values of the image signals for image display in the image display area of the panel.

One of the important factors in enhancing the image display quality in the panel is to enhance contrast. As one of the subfield methods, the following driving method is disclosed. In this method, the contrast ratio is increased by minimizing the light emission unrelated to gradation display so as to reduce the luminance in display of black, i.e. the lowest gradation.

In this driving method, a forced initializing operation is performed using a gently-changing ramp waveform voltage. In the initializing period of one subfield among a plurality of subfields forming one field, a forced initializing operation is performed. In the initializing periods of the other subfields, a selective initializing operation is performed. Thus, a forced initializing operation is performed once in a field.

The luminance of a region displaying black where no sustain discharge occurs (hereinafter, simply referred to as “luminance of black level”) changes with the light emission unrelated to image display, e.g. the light emission caused by an initializing discharge. In the above driving method, the light emission in the region displaying black is only the weak light emission caused when an initializing operation is performed in all the discharge cells. This allows display of an image of high contrast by reducing the luminance of black level (see Patent Literature 1, for example.)

Another driving method is disclosed so as to further enhance the contrast by further reducing the light emission unrelated to gradation display and thus luminance of black level (see Patent Literature 2, for example). For this purpose, display electrode pairs are divided into n parts and a forced initializing operation is performed once every n fields.

The driving method of Patent Literature 2 can make the luminance of black level lower than that of the driving method of Patent Literature 1 by reducing the number of forced initializing operations per unit time (e.g. one second).

However, the forced initializing operation serves to accumulate wall charge necessary for causing an address discharge in the succeeding address period and to generate priming particles for ensuring an address discharge by shortening the discharge delay time. The discharge delay time is a time taken after the voltage applied to a discharge cell exceeds a discharge start voltage before a discharge actually occurs. The longer discharge delay time destabilizes the discharge.

Thus, omission of the forced initializing operation increases the discharge delay time of the address discharge. This destabilizes the address operation, or causes an operation failure, such as occurrence of no address discharge. Thus, a normal image cannot be displayed.

Therefore, even in the driving method of Patent Literature 2, a forced initializing operation needs to be performed. As a result, even in a discharge cell displaying black without a sustain discharge, a light emission is caused by the forced initializing operation.

As described above, with the conventional techniques, omission of the forced initializing operation is difficult. This means that even a discharge cell displaying black emits light. This light emission imposes a limitation on enhancement of contrast.

### CITATION LIST

### Patent Literature

PTL1
Japanese Patent Unexamined Publication No. 2000-242224

PTL2
Japanese Patent Unexamined Publication No. 2006-091295

### SUMMARY OF THE INVENTION

In a driving method for a panel of the present invention, the panel has a plurality of discharge cells, and each of the discharge cells has a scan electrode, a sustain electrode, and a data electrode. One field is formed of a plurality of subfields, each having an address period, a sustain period, and an erasing period. In the address period, a scan pulse is applied to the scan electrodes, and an address pulse is applied to the data electrodes so as to selectively cause an address discharge in the discharge cells. In the sustain period, sustain pulses corresponding in number to a luminance weight are applied alternately to the scan electrodes and the sustain electrodes so as to cause a sustain discharge in the discharge cells having undergone the address discharge. In the erasing period, a predetermined voltage is applied to the scan electrodes and the sustain electrodes so as to selectively cause an erasing discharge only in the discharge cells having undergone the address discharge in the immediately preceding address period. The voltage obtained by subtracting the voltage applied to the data electrode from the low-side voltage of the sustain pulses applied to the scan electrode in the sustain period is defined as a first voltage. The voltage obtained by subtracting the voltage applied to the data electrode from the high-side voltage of the sustain pulses applied to the scan electrode in the sustain period is defined as a second voltage. The voltage obtained by subtracting the low-side voltage of the address pulse applied to the data electrode from the low-side voltage of the scan pulse applied to the scan electrode in the address period is defined as a third voltage.

Based on the above definitions, the voltage applied to each electrode is set so as to satisfy the conditions that

the voltage obtained by subtracting the third voltage from the first voltage is equal to or higher than the discharge start voltage of the discharge occurring between the data electrode as an anode and the scan electrode as a cathode, and

the voltage obtained by subtracting the third voltage from the second voltage is equal to or lower than the sum of the discharge start voltage of the discharge occurring between the data electrode as an anode and the scan electrode as a cathode and the discharge start voltage of the discharge occurring between the data electrode as a cathode and the scan electrode as an anode.

The one field has a first subfield and a second subfield. When the scan pulse is applied to each of the plurality of scan electrodes in the address period, the scan pulse is applied sequentially from one to another one of the scan electrodes in the first subfield, and is applied sequentially from another one to the one of the scan electrodes in the second subfield.

This method allows a stable address operation without a forced initializing operation and thus suppresses luminance of black level, thereby enhancing the contrast of a display image. Further, when the display image switches from a black image to a normal image, a stable address discharge is caused so as to display an image with high image display quality.

In the driving method for the panel of the present invention, the scan electrode may be applied with a voltage ranging from the low-side voltage of the scan pulse to the high-side voltage of the sustain pulses, inclusive.

In the driving method for the panel of the present invention, the absolute value of the low-side voltage of the scan pulse may be greater than the absolute value of the high-side voltage of the sustain pulses.

In the driving method for the panel of the present invention, in the address period of the first subfield, the scan pulse may be applied sequentially from the one of the scan electrodes disposed at one end of the panel to another one of the scan electrodes disposed at the other end of the panel. In the address period of the second subfield, the scan pulse may be applied sequentially from another one of the scan electrodes disposed at the other end to the one of the scan electrodes disposed at the one end.

In the driving method for the panel of the present invention, the first subfield and the second subfield may be generated alternately in the one field.

In the driving method for the panel of the present invention, a first field and a second field may be generated alternately. In the first field, the subfield occurring first in the field is one of the first subfield and the second subfield. In the second field, the subfield occurring first in the field is the remainder of the first subfield and the second subfield.

In the driving method for the panel of the present invention, the panel includes a discharge cell applied with a phosphor for emitting red light, a discharge cell applied with a phosphor for emitting green light, and a discharge cell applied with a phosphor for emitting blue light. In the sustain period of at least one subfield among the plurality of subfields forming one field, the voltage applied to the data electrode of the discharge cell applied with the phosphor for emitting green light may be lower than the voltage applied to the data electrode of the discharge cell applied with the phosphor for emitting red light and the voltage applied to the data electrode of the discharge cell applied with the phosphor for emitting blue light.

In the driving method for the panel of the present invention, in the sustain period of the subfield having the lightest luminance weight, the voltage applied to the data electrode of the discharge cell applied with the phosphor for emitting green light may be lower than the voltage applied to the data electrode of the discharge cell applied with the phosphor for emitting red light and the voltage applied to the data electrode of the discharge cell applied with the phosphor for emitting blue light.

In the driving method for the panel of the present invention, the voltage applied to the data electrode of the discharge cell applied with the phosphor for emitting green light may be lower in the sustain period of the subfield having the lightest luminance weight than in the sustain periods of the subfields except the subfield having the lightest luminance weight.

In the driving method for the panel of the present invention, in the erasing period, a first discharge between the sustain electrode as a cathode and the scan electrode as an anode may be caused. Thereafter, a first discharge between the scan electrode as a cathode and the data electrode as an anode may be caused. Thereafter, a second discharge between the sustain electrode as a cathode and the scan electrode as an anode may be caused. Thereafter, a second discharge between the scan electrode as a cathode and the data electrode as an anode may be caused.

In the driving method for the panel of the present invention, in the erasing period, voltages may be applied in the following manner. While a fourth voltage is applied to the sustain electrodes, an up-ramp waveform voltage, a down-ramp waveform voltage, and a positive rectangular waveform voltage are applied to the scan electrodes in this order. Thereafter, while a fifth voltage higher than the fourth voltage is applied to the sustain electrodes, a down-ramp waveform voltage is applied to the scan electrodes.

In the driving method for the panel of the present invention, at least one subfield may be set in one field, and when the positive rectangular waveform voltage is applied to the scan electrodes in the erasing period of this at least one subfield, the voltage applied to the data electrode of the discharge cell applied with the phosphor for emitting green light is lower than the voltage applied to the data electrode of the discharge cell applied with the phosphor for emitting red light and the voltage applied to the data electrode of the discharge cell applied with the phosphor for emitting blue light.

A plasma display apparatus of the present invention includes the following elements:

a panel having a plurality of discharge cells, each of the discharge cells having a scan electrode, a sustain electrode, and a data electrode; and

a driver circuit for driving the panel and displaying an image on the panel.

The driver circuit drives the panel in the following manner. One field is formed of a plurality of subfields, each having an address period, a sustain period, and an erasing period. In the address period, a scan pulse is applied to the scan electrodes, and an address pulse is applied to the data electrodes so as to selectively cause an address discharge in the discharge cells. In the sustain period, sustain pulses corresponding in number to a luminance weight are applied alternately to the scan electrodes and the sustain electrodes so as to cause a sustain discharge in the discharge cells having undergone the address discharge. In the erasing period, a predetermined voltage is applied to the scan electrodes and the sustain electrodes so as to selectively cause an erasing discharge only in the discharge cells having undergone the address discharge in the immediately preceding address period. The voltage obtained by subtracting the voltage applied to the data electrode from the low-side voltage of the sustain pulses applied to the scan electrode in the sustain period is defined as a first voltage. The voltage obtained by subtracting the voltage applied to the data electrode from the high-side voltage of the sustain pulses applied to the scan electrode in the sustain period is defined as a second voltage. The voltage obtained by subtracting the low-side voltage of the address pulse applied to the data electrode from the low-side voltage of the scan pulse applied to the scan electrode in the address period is defined as a third voltage.

Based on the above definitions, the voltage applied to each electrode is set so as to satisfy the conditions that

the voltage obtained by subtracting the third voltage from the first voltage is equal to or higher than the discharge start voltage of the discharge occurring between the data electrode as an anode and the scan electrode as a cathode, and

the voltage obtained by subtracting the third voltage from the second voltage is equal to or lower than the sum of the discharge start voltage of the discharge occurring between the data electrode as an anode and the scan electrode as a cathode and the discharge start voltage of the discharge occurring between the data electrode as a cathode and the scan electrode as an anode.

The one field has a first subfield and a second subfield. When the scan pulse is applied to each of the plurality of scan electrodes in the address period, the scan pulse is applied sequentially from one to another one of the scan electrodes in the first subfield, and is applied sequentially from another one to the one of the scan electrodes in the second subfield.

This configuration allows a stable address operation without a forced initializing operation and thus suppresses luminance of black level, thereby enhancing the contrast of a display image. Further, when the display image switches from a black image to a normal image, a stable address discharge is caused so as to display an image with high image display quality.

### BRIEF DESCRIPTION OF DRAWINGS

FIG. 1 is an exploded perspective view showing a structure of a panel for use in a plasma display apparatus in accordance with a first exemplary embodiment of the present invention.

FIG. 2 is an electrode array diagram of the panel for use in the plasma display apparatus in accordance with the first exemplary embodiment.

FIG. 3 is chart schematically showing driving voltage waveforms in a first field applied to the respective electrodes of the panel for use in the plasma display apparatus in accordance with the first exemplary embodiment.

FIG. 4 is chart schematically showing driving voltage waveforms in a second field applied to the respective electrodes of the panel for use in the plasma display apparatus in accordance with the first exemplary embodiment.

FIG. 5 is a diagram showing voltages applied to scan electrode 22 and data electrode 32 in one subfield in accordance with the first exemplary embodiment.

FIG. 6 is a diagram showing an example of a method for measuring a discharge start voltage in a simple manner.

FIG. 7 is a circuit block diagram of the plasma display apparatus in accordance with the first exemplary embodiment.

FIG. 8 is a circuit diagram schematically showing a scan electrode driver circuit of the plasma display apparatus in accordance with the first exemplary embodiment.

FIG. 9 is a circuit diagram schematically showing a sustain electrode driver circuit of the plasma display apparatus in accordance with the first exemplary embodiment.

FIG. 10 is a circuit diagram schematically showing a data electrode driver circuit of the plasma display apparatus in accordance with the first exemplary embodiment.

FIG. 11 is a chart schematically showing driving voltage waveforms in a first field applied to the respective electrodes of the panel for use in the plasma display apparatus in accordance with a second exemplary embodiment of the present invention.

FIG. 12 is a chart schematically showing driving voltage waveforms in a second field applied to the respective electrodes of the panel for use in the plasma display apparatus in accordance with the second exemplary embodiment.

FIG. 13A is a chart schematically showing an example of order in which scan pulses are applied to the scan electrodes in the panel for use in the plasma display apparatus in accordance with the second exemplary embodiment.

FIG. 13B is a chart schematically showing another example of order in which scan pulses are applied to the scan electrodes in the panel for use in the plasma display apparatus in accordance with the second exemplary embodiment.

FIG. 13C is a chart schematically showing still another example of order in which scan pulses are applied to the scan electrodes in the panel for use in the plasma display apparatus in accordance with the second exemplary embodiment.

FIG. 14A is a chart schematically showing yet another example of order in which scan pulses are applied to the scan electrodes in the panel for use in the plasma display apparatus in accordance with the second exemplary embodiment.

FIG. 14B is a chart schematically showing still another example of order in which scan pulses are applied to the scan electrodes in the panel for use in the plasma display apparatus in accordance with the second exemplary embodiment.

FIG. 14C is a chart schematically showing yet another example of order in which scan pulses are applied to the scan electrodes in the panel for use in the plasma display apparatus in accordance with the second exemplary embodiment.

FIG. 14D is a chart schematically showing still another example of order in which scan pulses are applied to the scan electrodes in the panel for use in the plasma display apparatus in accordance with the second exemplary embodiment.

FIG. 14E is a chart schematically showing yet another example of order in which scan pulses are applied to the scan electrodes in the panel for use in the plasma display apparatus in accordance with the second exemplary embodiment.

FIG. 15A is a chart schematically showing still another example of order in which scan pulses are applied to the scan electrodes in the panel for use in the plasma display apparatus in accordance with the second exemplary embodiment.

FIG. 15B is a chart schematically showing yet another example of order in which scan pulses are applied to the scan electrodes in the panel for use in the plasma display apparatus in accordance with the second exemplary embodiment.

FIG. 15C is a chart schematically showing still another example of order in which scan pulses are applied to the scan electrodes in the panel for use in the plasma display apparatus in accordance with the second exemplary embodiment.

FIG. 16A is a chart schematically showing yet another example of order in which scan pulses are applied to the scan electrodes in the panel for use in the plasma display apparatus in accordance with the second exemplary embodiment.

FIG. 16B is a chart schematically showing still another example of order in which scan pulses are applied to the scan electrodes in the panel for use in the plasma display apparatus in accordance with the second exemplary embodiment.

FIG. 16C is a chart schematically showing yet another example of order in which scan pulses are applied to the scan electrodes in the panel for use in the plasma display apparatus in accordance with the second exemplary embodiment.

FIG. 16D is a chart schematically showing still another example of order in which scan pulses are applied to the scan electrodes in the panel for use in the plasma display apparatus in accordance with the second exemplary embodiment.

### DESCRIPTION OF EMBODIMENTS

Hereinafter, a description is provided for a plasma display apparatus in accordance with the exemplary embodiments of the present invention with reference to the accompanying drawings.

### First Exemplary Embodiment

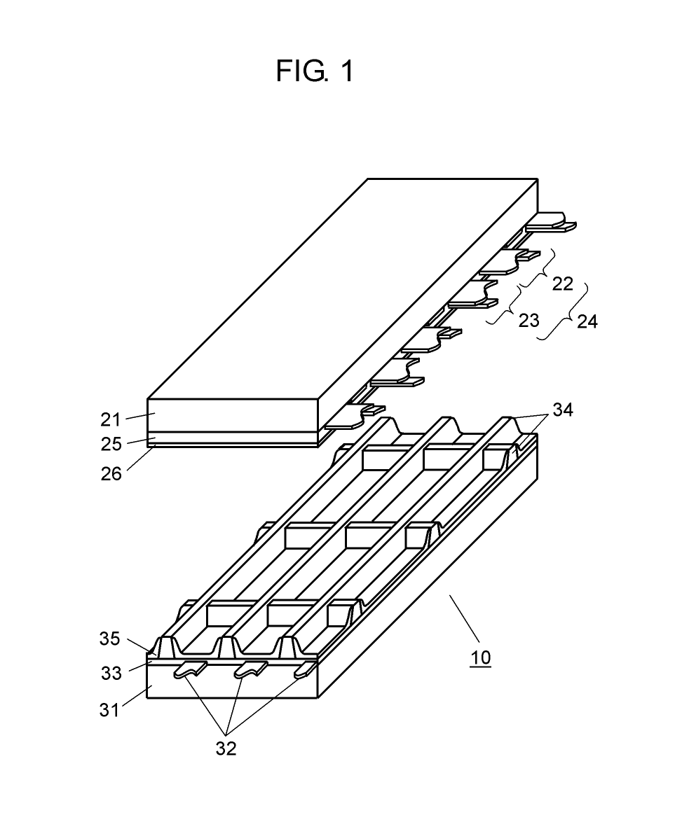

FIG. 1 is an exploded perspective view showing a structure of panel 10 for use in the plasma display apparatus in accordance with the first exemplary embodiment of the present invention. A plurality of display electrode pairs 24, each including scan electrode 22 and sustain electrode 23, is formed on glass front substrate 21. Dielectric layer 25 is formed so as to cover scan electrodes 22 and sustain electrodes 23. Protective layer 26 is formed over dielectric layer 25.

In order to facilitate discharge by lowering a discharge start voltage in discharge cells, protective layer 26 is formed of a material containing magnesium oxide (MgO), which has high electron emission performance and excellent durability.

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layer 35R for emitting light of red color (R), phosphor layer 35G for emitting light of green color (G), and phosphor layer 35B for emitting light of blue color (B) are formed. Hereinafter, phosphor layer 35R, phosphor layer 35G, and phosphor layer 35B are also generically referred to as phosphor layers 35.

In this exemplary embodiment, a phosphor predominantly composed of (Y, Gd) BO₃: Eu, for example, is used as a red phosphor. A phosphor predominantly composed of Zn₂SiO₄: Mn, for example, is used as a green phosphor. A phosphor predominantly composed of BaMgAl₁₀O₁₇: Eu, for example, is used as a blue phosphor. However, in the present invention, the phosphors that form phosphor layers 35 are not limited to the above phosphors.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a neon-xenon mixture gas, for example, is sealed as a discharge gas.

The discharge space is partitioned into a plurality of compartments by barrier ribs 34. Discharge cells are formed in the intersecting parts of display electrode pairs 24 and data electrodes 32.

In these discharge cells, a discharge occurs so as to cause phosphor layers 35 of the discharge cells to emit light (to be lit). Thus, a color image is displayed on panel 10.

In panel 10, three consecutive discharge cells arranged in the extending direction of display electrode pair 24, i.e. a discharge cell for emitting light of red color (R), a discharge cell for emitting light of green color (G), and a discharge cell for emitting light of blue color (B), form one pixel.

The structure of panel 10 is not limited to the above, and rear substrate 31 may include barrier ribs in a stripe pattern, for example.

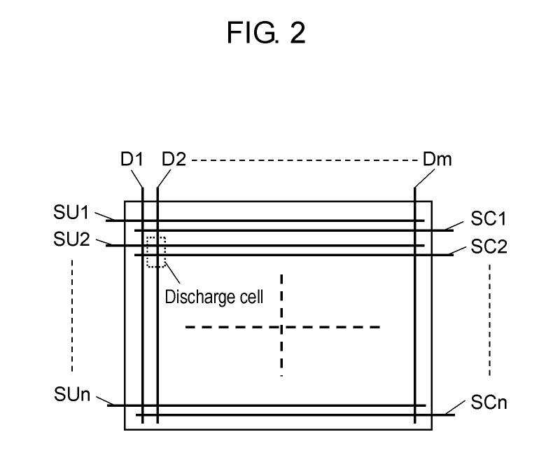

FIG. 2 is an electrode array diagram of panel 10 for use in the plasma display apparatus in accordance with the first exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) extending in the horizontal direction (line direction), and m data electrode D1-data electrode Dm (data electrodes 32 in FIG. 1) extending in the vertical direction (column direction). A discharge cell is formed in the part where a pair of scan electrode SCi (i=1-n) and sustain electrode SUi intersects one data electrode Dj (j=1-m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920×3 and n=1080.

For example, the red phosphor is applied to the discharge cell having data electrode Dp (p=3×q−2 where q is an integer except 0 that is equal to or smaller than m/3) as phosphor layer 35R. The green phosphor is applied to the discharge cell having data electrode Dp+1 as phosphor layer 35G, and the blue phosphor is applied to the discharge cell having data electrode Dp+2 as phosphor layer 35B.

Next, a description is provided for driving voltage waveforms for driving panel 10 and the outline of the operation.

The plasma display apparatus of this exemplary embodiment drives panel 10 by a subfield method. In the subfield method, one field is divided into a plurality of subfields along a temporal axis, and a luminance weight is set for each subfield. Therefore, each field has a plurality of subfields. An image is displayed on panel 10 by controlling the light emission and no light emission in each discharge cell in each subfield.

The luminance weight represents a ratio of the magnitude of luminance displayed in each subfield. In the sustain period of each subfield, sustain pulses corresponding in number to the luminance weight are generated. For example, the luminance of the light emission in the subfield having the luminance weight “8” is approximately eight times as high as that in the subfield having the luminance weight “1”, and is approximately four times as high as that in the subfield having the luminance weight “2”. Thus, various gradations and an image can be displayed on panel 10 by selectively causing light emission in each subfield in combination in response to image signals.

In this exemplary embodiment, each subfield has an address period, a sustain period, and an erasing period. In this exemplary embodiment, no forced initializing operation is performed. The forced initializing operation is an initializing operation for forcedly causing an initializing discharge in the discharge cells regardless of whether a discharge has occurred or not.

In each address period, an address operation is performed in the following manner. A scan pulse is applied to scan electrodes 22 and an address pulse (data pulse) is applied selectively to data electrodes 32 so as to cause an address discharge selectively in the discharge cells to be lit. The address operation forms wall charge for causing a sustain discharge in the succeeding sustain period in the discharge cells.

In the sustain period of each subfield, sustain pulses corresponding in number to the luminance weight of the subfield multiplied by a predetermined proportionality factor are applied alternately to scan electrodes 22 and sustain electrodes 23. This proportionality factor is a luminance magnification. For instance, when the luminance magnification is 2, in the sustain period of a subfield having the luminance weight “2”, four sustain pulses are applied to each of scan electrodes 22 and sustain electrodes 23. Thus, the number of sustain pulses generated in the sustain period is 8. Then, a sustain discharge occurs in the discharge cells having undergone an address discharge in the immediately preceding address period, and the discharge cells are lit. This operation of applying sustain pulses to the discharge cells so as to light the discharge cells is a sustain operation.

In order to suppress the emission luminance to a low level, a subfield where the sustain period is omitted may be set.

In each erasing period, an erasing discharge occurs only in the discharge cells having undergone an address discharge in the address period of the subfield to which the erasing period belongs. Therefore, this erasing discharge selectively occurs only in the discharge cells having undergone the address discharge. This erasing discharge erases the wall charge formed by the address discharge or the succeeding sustain discharge, and forms wall charge necessary for the address discharge in the succeeding subfield on the respective electrodes. Hereinafter, these operations are also referred to as “erasing operation”.

Hereinafter, in this exemplary embodiment, a description is provided for an example where one field is divided into 10 subfields (SF1, SF2, . . . , SF10), and the subfields have respective luminance weights of 1, 2, 3, 6, 11, 18, 30, 44, 60, and 80.

In this exemplary embodiment, a first subfield and a second subfield are generated so as to be repeated alternately. Between the first subfield and the second subfield, the order of address operations performed in the respective discharge cells in the address period is different. In this exemplary embodiment, an image is displayed on panel 10 such that a first field and a second field are generated so as to be repeated alternately. In the first field, subfield SF1 is a first subfield. In the second field, subfield SF1 is a second subfield. Hereinafter, a description is provided for a first field first, and for a second field next.

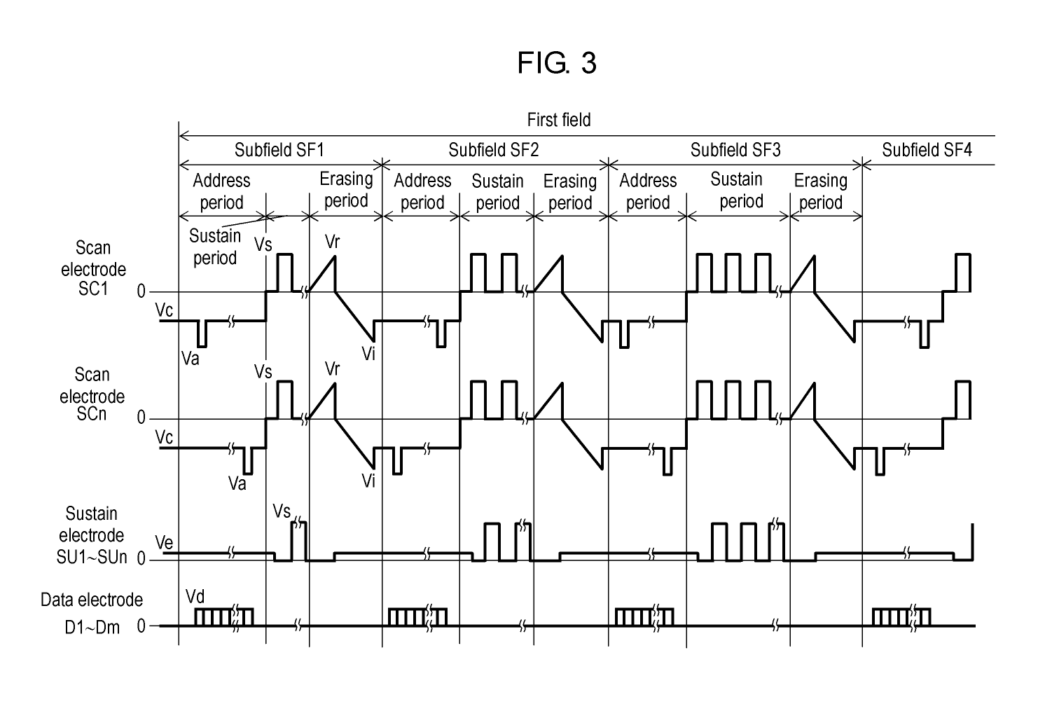

FIG. 3 is chart schematically showing driving voltage waveforms in a first field applied to the respective electrodes of panel 10 for use in the plasma display apparatus in accordance with the first exemplary embodiment of the present invention.

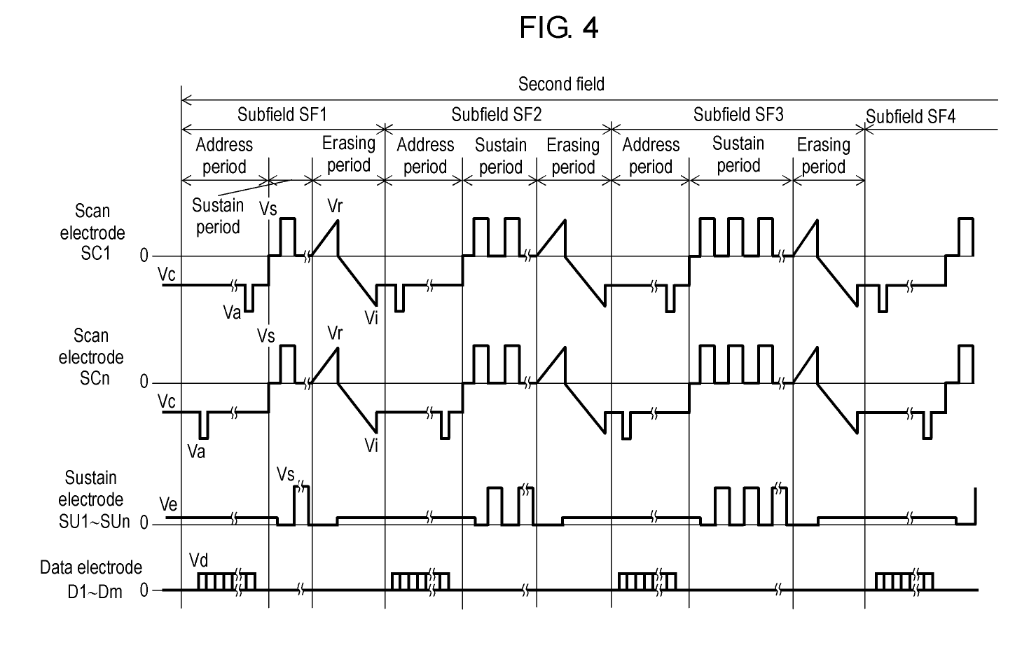

FIG. 4 is chart schematically showing driving voltage waveforms in a second field applied to the respective electrodes of panel 10 for use in the plasma display apparatus in accordance with the first exemplary embodiment of the present invention.

FIG. 3 and FIG. 4 show driving voltage waveforms applied to the following electrodes: scan electrode SC1 to undergo an address operation first in the address periods; scan electrode SCn to undergo an address operation last in the address periods; sustain electrode SU1-sustain electrode SUn; and data electrode D1-data electrode Dm. Scan electrode SCi, sustain electrode SUi, and data electrode Dk in the following description are the electrodes selected from the respective electrodes, based on image data (data representing light emission and no light emission in each subfield).

FIG. 3 and FIG. 4 mainly show driving voltage waveforms in three subfields, i.e. subfield SF1, subfield SF2, and subfield SF3.

First, a first field is described with reference to FIG. 3.

In this exemplary embodiment, subfield SF1 in the first field is a first subfield. In the address period of the first subfield, a scan pulse is applied sequentially from scan electrode SC1, i.e. scan electrode 22 disposed at one end of panel 10 (one scan electrode 22) to scan electrode SCn, i.e. scan electrode 22 disposed at the other end of panel 10 (another scan electrode 22) among the plurality of scan electrodes 22 formed in panel 10.

In the address period of subfield SF1 in the first field in FIG. 3, voltage 0 (V) is applied to data electrode D1-data electrode Dm, voltage Ve is applied to sustain electrode SU1-sustain electrode SUn, and voltage Vc is applied to scan electrode SC1-scan electrode SCn.

Next, negative voltage Va is applied to scan electrode SC1 in the first line, which undergoes an address operation first. That is, a negative scan pulse is applied. Further, an address pulse (data pulse) at positive voltage Vd is applied to data electrode Dk of a discharge cell to be lit in the first line among data electrode D1-data electrode Dm.

The voltage difference in the intersecting part of data electrode Dk and scan electrode SC1 in the discharge cell applied with the address pulse at voltage Vd is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds discharge start voltage VFds, and a discharge occurs between data electrode Dk and scan electrode SC1.

Since voltage Ve is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltageVe−voltageVa). At this time, setting voltage Ve to a voltage value slightly lower than the discharge start voltage can make the state where a discharge is likely to occur but does not actually occurs between sustain electrode SU1 and scan electrode SC1.

With this setting, a discharge occurring between data electrode Dk and scan electrode SC1 induces a discharge between the areas of sustain electrode SU1 and scan electrode SC1 intersecting data electrode Dk. Thus, an address discharge occurs in the discharge cell applied with a scan pulse and an address pulse at the same time (the discharge cell to be lit). Positive wall voltage accumulates on scan electrode SC1, and negative wall voltage accumulates on sustain electrode SU1. Negative wall voltage also accumulates on data electrode Dk.

These wall voltages on the electrodes mean voltages that are generated by the wall charge accumulated on dielectric layer 25 covering the electrodes, protective layer 26, phosphor layers 35, or the like.

In this manner, an address operation is performed so as to cause an address discharge in the discharge cells to be lit in the first line and accumulate wall voltages on the respective electrodes. In contrast, the voltage in the intersecting part of scan electrode SC1 and data electrode Dh applied with no address pulse does not exceed discharge start voltage VFds, and thus no address discharge occurs.

Next, a scan pulse is applied to scan electrode SC2 in the second line and an address pulse is applied to data electrode Dk corresponding to a discharge cell to be lit in the second line. This causes an address discharge between data electrode Dk and scan electrode SC2, and between sustain electrode SU2 and scan electrode SC2. Positive wall voltage accumulates on scan electrode SC2, and negative wall voltage accumulates on sustain electrode SU2. Negative wall voltage also accumulates on data electrode Dk.

In contrast, the voltage in the intersecting part of scan electrode SC2 and data electrode Dh applied with no address pulse does not exceed discharge start voltage VFds, and thus no address discharge occurs. In this manner, an address operation is performed so as to cause an address discharge in the discharge cells to be lit in the second line and accumulate wall voltages on the respective electrodes.

The similar address operation is performed on scan electrode SC3 in the third line, scan electrode SC4 in the fourth line, . . . , scan electrode SC(n−1) in the (n−1)-th line, and scan electrode SCn in the n-th line in this order sequentially from the discharge cells in the third line to the discharge cells in the n-th line. Thus, the address period of subfield SF1 is completed.

In this manner, in the address period of subfield SF1 in the first field, i.e. a first subfield, an address operation is performed in the discharge cells in the first line, the discharge cells in the second line, the discharge cells in the third line, . . . , the discharge cells in the (n−1)-th line, and the discharge cells in the n-th line in this order. Thereby, wall charge necessary for a sustain discharge is formed in the discharge cells to be lit in the subfield.

Here, for the following description, first voltage V1, second voltage V2, and third voltage V3 are defined as follows.

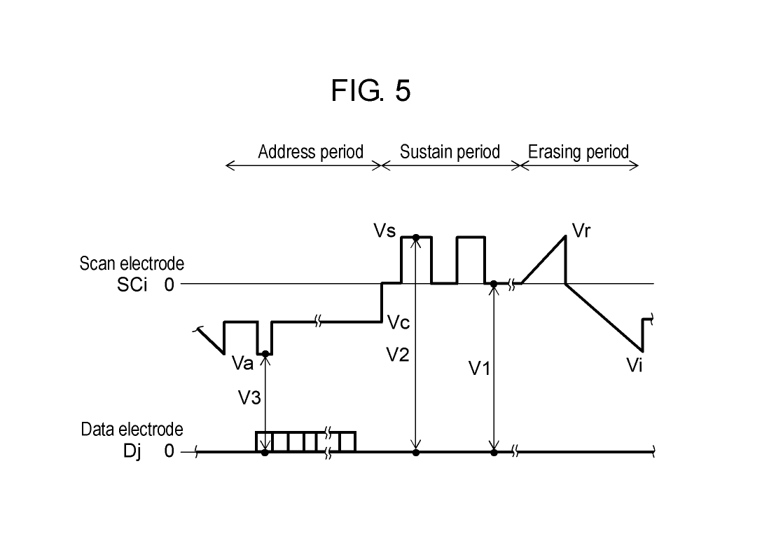

FIG. 5 is a diagram showing voltages applied to scan electrode 22 and data electrode 32 in one subfield in accordance with the first exemplary embodiment of the present invention.

In this exemplary embodiment, the voltage obtained by subtracting the voltage applied to data electrode Dj (voltage 0 (V) in FIG. 3 and FIG. 4) from the low-side voltage of the sustain pulses applied to scan electrode SCi (voltage 0 (V) in FIG. 3 and FIG. 4) in the sustain period is defined as first voltage V1. The voltage obtained by subtracting the voltage applied to data electrode Dj (voltage 0 (V) in FIG. 3 and FIG. 4) from the high-side voltage of the sustain pulses applied to scan electrode SCi (voltage Vs in FIG. 3 and FIG. 4) in the sustain period is defined as second voltage V2. The voltage obtained by subtracting the low-side voltage of the address pulse applied to data electrode Dj (voltage 0 (V) in FIG. 3 and FIG. 4) from the low-side voltage of the scan pulse applied to scan electrode SCi (voltage Va in FIG. 3 and FIG. 4) in the address period is defined as third voltage V3.

Further, as described above, the discharge start voltage between data electrode Dj as an anode and scan electrode SCi as a cathode in the address period is defined as discharge start voltage VFds. The discharge start voltage between data electrode Dj as a cathode and scan electrode SCi as an anode in the sustain period is defined as discharge start voltage VFsd.

In the discharge between data electrode Dj as an anode and scan electrode SCi as a cathode, data electrode Dj is on the high potential side and scan electrode SCi is on the low potential side in the electric field in the discharge cell when the discharge occurs.

In the discharge between data electrode Dj as a cathode and scan electrode SCi as an anode, data electrode Dj is on the low potential side and scan electrode SCi is on the high potential side in the electric field in the discharge cell when the discharge occurs.

Since protective layer 26 of magnesium oxide, which has high electron emission performance, is formed on front substrate 21 having scan electrode SCi, discharge start voltage VFds is lower than discharge start voltage VFsd.

In this exemplary embodiment, voltage Va of the scan pulse applied to scan electrode SCi is set so as to satisfy the following two conditions: (Condition 1) and (Condition 2).

(Condition 1): In every discharge cell, the voltage obtained by subtracting third voltage V3 from first voltage V1 is equal to or higher than discharge start voltage VFds of a discharge between data electrode Dj as an anode and scan electrode SCi as a cathode. That is,

(V1−V3)≧VFds

(Condition 2): In every discharge cell, the voltage obtained by subtracting third voltage V3 from second voltage V2 is equal to or lower than the sum of discharge start voltage VFds of a discharge between data electrode Dj as an anode and scan electrode SCi as a cathode and discharge start voltage VFsd of a discharge between data electrode Dj as a cathode and scan electrode SCi as an anode. That is,

(V2−V3)≦(VFds+VFsd)

Next, the sustain period is described. In the sustain period succeeding the address period of subfield SF1 in FIG. 3, first, voltage 0 (V) is applied to sustain electrode SU1-sustain electrode SUn, and a sustain pulse at positive voltage Vs is applied to scan electrode SC1-scan electrode SCn.

With the application of the sustain pulse, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thereby, the voltage difference between scan electrode SCi and sustain electrode SUi exceeds discharge start voltage VFss and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In contrast, in the discharge cells having undergone no address discharge in the address period, no sustain discharge occurs and the wall voltages having been generated are maintained.

Subsequently, voltage 0 (V) is applied to scan electrode SC1-scan electrode SCn, and a sustain pulse at voltage Vs is applied to sustain electrode SU1-sustain electrode SUn. In the discharge cells having undergone the sustain discharge immediately before this voltage application, the voltage difference between sustain electrode SUi and scan electrode SCi exceeds discharge start voltage VFss. Thereby, a sustain discharge occurs between sustain electrode SUi and scan electrode SCi again, and phosphor layers 35 in the discharge cells having undergone the sustain discharge emit light. Negative wall voltage accumulates on sustain electrode SUi, and positive wall voltage accumulates on scan electrode SCi.

Similarly, sustain pulses equal in number to the luminance weight multiplied by a predetermined luminance magnification are applied alternately to scan electrode SC1-scan electrode SCn and sustain electrode SU1-sustain electrode SUn. Giving the electric potential difference to the electrodes of each display electrode pair 24 in this manner continuously causes a sustain discharge in the discharge cells having undergone the address discharge in the address period.

Thus, the sustain operation in the sustain period of subfield SF1 is completed.

Next, the erasing period is described. In the erasing period of subfield SF1, after the sustain pulses have been generated in the sustain period (at the end of the sustain period), an up-ramp waveform voltage gently rising from voltage 0 (V) toward voltage Vr is applied to scan electrode SC1-scan electrode SCn while voltage 0 (V) is applied to sustain electrode SU1-sustain electrode SUn and data electrode D1-data electrode Dm.

While the up-ramp waveform voltage applied to scan electrode SC1-scan electrode SCn is rising above the discharge start voltage, a weak erasing discharge continuously occurs in the discharge cells having undergone the sustain discharge in the sustain period of the subfield (the discharge cells having undergone the address discharge in the subfield where the sustain period is omitted). The charged particles generated by this erasing discharge accumulate on sustain electrode SUi and scan electrode SCi as wall charge so as to reduce the voltage difference between sustain electrode SUi and scan electrode SCi. This reduces the wall voltages on scan electrode SCi and sustain electrode SUi while the positive wall voltage is left on data electrode Dk. That is, the erasing discharge erases unnecessary wall charge in the discharge cell.

After the voltage applied to scan electrode SC1-scan electrode SCn has reached voltage Vr, the voltage applied to scan electrode SC1-scan electrode SCn is lowered to voltage 0 (V).

In this exemplary embodiment, voltage Vr and voltage Vs are set to an equal voltage value. However, voltage Vr and voltage Vs may have different voltage values. Preferably, voltage Vr is set to a voltage value optimum for the characteristics of panel 10, the specifications of the plasma display apparatus, or the like.

Thereafter, voltage Ve is applied to sustain electrode SU1-sustain electrode SUn, and voltage 0 (V) is applied to data electrode D1-data electrode Dm. A down-ramp waveform voltage gently falling from voltage 0 (V) to voltage Vi is applied to scan electrode SC1-scan electrode SCn. This voltage Vi is set to a voltage value equal to or slightly higher than that of voltage Va of the scan pulse.

With this voltage application, a weak discharge occurs again in the discharge cells having undergone a weak erasing discharge. This weak discharge discharges the excess part of the wall voltage on scan electrode SCi, the wall voltage on sustain electrode SUi, and the wall voltage on data electrode Dk. The wall voltages are adjusted so as to be suitable for the address operation. Thus, the erasing period is completed.

In this manner, subfield SF1 in the first field is completed.

Next, subfield SF2 in the first field is described.

In this exemplary embodiment, subfield SF2 in the first field is a second subfield. In the address period of the second subfield, a scan pulse is applied sequentially from scan electrode SCn, i.e. the scan electrode disposed at the other end of panel 10 (another scan electrode 22) to scan electrode SC1, i.e. scan electrode 22 disposed at the one end of panel 10 (one scan electrode 22) among the plurality of scan electrodes 22 formed in panel 10.

In the address period of subfield SF2 in the first field, similarly to the address period of subfield SF1 in the first field, voltage 0 (V) is applied to data electrode D1-data electrode Dm, voltage Ve is applied to sustain electrode SU1-sustain electrode SUn, and voltage Vc is applied to scan electrode SC1-scan electrode SCn.

However, since subfield SF2 in the first field is a second subfield, differently from the address period of subfield SF1 in the first field, scan electrode 22 that undergoes an address operation first in the address period is scan electrode SCn in the n-th line.

Therefore, a negative scan pulse at voltage Va is applied to scan electrode SCn in the n-th line, which undergoes an address operation first. Further, an address pulse (data pulse) at positive voltage Vd is applied to data electrode Dk of a discharge cell to be lit in the n-th line among data electrode D1-data electrode Dm.

At this time, voltage Va is set so as to satisfy (Condition 1) and (Condition 2).

Thus, an address discharge occurs between data electrode Dk and scan electrode SCn and between sustain electrode SUn and scan electrode SCn.

Positive wall voltage accumulates on scan electrode SCn, and negative wall voltage accumulates on sustain electrode SUn. Negative wall voltage also accumulates on data electrode Dk. In this manner, an address operation is performed so as to cause an address discharge in the discharge cells to be lit in the n-th line and accumulate wall voltages on the respective electrodes.

Next, a scan pulse at voltage Va is applied to scan electrode SC(n−1) in the (n−1)-th line and an address pulse at voltage Vd is applied to data electrode Dk corresponding to a discharge cell to be lit in the (n−1)-th line. Thus, an address operation is performed in the discharge cells in the (n−1)-th line.

The similar address operation is performed on scan electrode SC(n−2) in the (n−2)-th line, scan electrode SC(n−3) in the (n−3)-th line, . . . , scan electrode SC2 in the second line, and scan electrode SC1 in the first line in this order sequentially from the discharge cells in the (n−2)-th line to the discharge cells in the first line. Thus, the address period of subfield SF2 is completed.

In this manner, in the address period of subfield SF2 in the first field, i.e. a second subfield, oppositely to the address period of subfield SF1 in the first field, an address operation is performed in the discharge cells in the n-th line, the discharge cells in the (n−1)-th line, the discharge cells in the (n−2)-th line, . . . , the discharge cells in the second line, and the discharge cells in the first line in this order. That is, the order of the address operations in the respective discharge cells in the address period of a second subfield (subfield SF2 in a first field) is opposite to the order of the address operations in the respective discharge cells in the address period of a first subfield (subfield SF1 in the first field).

In the sustain period of subfield SF2 in the first field, similarly to the sustain period of subfield SF1, sustain pulses corresponding in number to the luminance weight are applied alternately to scan electrode SC1-scan electrode SCn and sustain electrode SU1-sustain electrode SUn. Thereby, a sustain discharge occurs in the discharge cells having undergone an address discharge in the address period.

Further, in the erasing period of subfield SF2 in the first field, driving voltage waveforms similar to those in the erasing period of subfield SF1 in the first field are applied to the respective electrodes for erasing operation.

Next, subfield SF3 in the first field is described.

In this exemplary embodiment, subfield SF3 in the first field is a first subfield. Thus, in the address period of subfield SF3 in the first field, an address operation is performed so as to apply driving voltage waveforms similar to those in the address period of subfield SF1 in the first field to the respective electrodes and accumulate wall voltages on the respective electrodes of the discharge cells to be lit.

That is, in the address period of subfield SF3 in the first field, similarly to the address period of subfield SF1 in the first field, an address operation is performed in the discharge cells in the first line, the discharge cells in the second line, the discharge cells in the third line, . . . , the discharge cells in the (n−1)-th line, and the discharge cells in the n-th line in this order. Thus, the order of address operations in the respective discharge cells in the address period of subfield SF3 in the first field is opposite to that in the address period of subfield SF2 in the first field.

In the sustain period and the erasing period of subfield SF3 in the first field, the respective electrodes are applied with the driving voltage waveforms similar to those in the sustain period and the erasing period of subfield SF1 in the first field except for the number of sustain pulses.

Next, subfield SF4 in the first field is described.

In this exemplary embodiment, subfield SF4 in the first field is a second subfield. Thus, in the address period of subfield SF4 in the first field, an address operation is performed so as to apply driving voltage waveforms similar to those in the address period of subfield SF2 in the first field to the respective electrodes and accumulate wall voltages on the respective electrodes of the discharge cells to be lit.

That is, in the address period of subfield SF4 in the first field, similarly to the address period of subfield SF2 in the first field, an address operation is performed in the discharge cells in the n-th line, the discharge cells in the (n−1)-th line, the discharge cells in the (n−2)-th line, . . . , the discharge cells in the second line, and the discharge cells in the first line in this order. Thus, the order of the address operations in the respective discharge cells in the address period of subfield SF4 in the first field is opposite to that in the address period of subfield SF3 in the first field.

In the sustain period and the erasing period of subfield SF4 in the first field, the respective electrodes are applied with the driving voltage waveforms similar to those in the sustain period and the erasing period of subfield SF1 in the first field except for the number of sustain pulses.

In this exemplary embodiment, each of subfield SF5, subfield SF7, and subfield SF9 in a first field is a first subfield. Thus, in each of subfield SF5, subfield SF7, and subfield SF9 in the first field, an address operation is performed in the respective discharge cells in the order same as that in the address period of subfield SF1 in the first field.

Further, in this exemplary embodiment, each of subfield SF6, subfield SF8, and subfield SF10 in the first field is a second subfield. Thus, in each of subfield SF6, subfield SF8, and subfield SF10 in the first field, an address operation is performed in the respective discharge cells in the order same as that in the address period of subfield SF2 in the first field.

In the sustain period and the erasing period of each of subfield SF5 through subfield SF10, the respective electrodes are applied with the driving voltage waveforms similar to those in the sustain period and the erasing period of subfield SF1 in the first field except for the number of sustain pulses.

As described above, in this exemplary embodiment, subfields occurring in the odd-numbered positions in a first field (subfield SF1, subfield SF3, subfield SF5, subfield SF7, and subfield SF9 in this exemplary embodiment) are first subfields. Subfields occurring in the even-numbered positions (subfield SF2, subfield SF4, subfield SF6, subfield SF8, and subfield SF10 in this exemplary embodiment) are second subfields.

In the address period of a first subfield, a scan pulse is applied sequentially from scan electrode SC1, i.e. one scan electrode 22, to scan electrode SCn, i.e. another scan electrode 22, among the plurality of scan electrodes 22 formed in panel 10. That is, an address operation is performed in the discharge cells in the first line, the discharge cells in the second line, the discharge cells in the third line, . . . , the discharge cells in the (n−1)-th line, and the discharge cells in the n-th line in this order.

In the address period of a second subfield, a scan pulse is applied sequentially from scan electrode SCn, i.e. another scan electrode 22, to scan electrode SC1, i.e. one scan electrode 22, among the plurality of scan electrodes 22 formed in panel 10. That is, an address operation is performed in the discharge cells in the n-th line, the discharge cells in the (n−1)-th line, the discharge cells in the (n−2)-th line, . . . , the discharge cells in the second line, and the discharge cells in the first line in this order.

Therefore, in a first field, an address operation is performed in the respective discharge cells in the address periods of the respective subfields except subfield SF1 in the order opposite to the address operations in the respective discharge cells in the address periods of the immediately preceding subfields.

Next, a second field is described with reference to FIG. 4.

In this exemplary embodiment, subfield SF1 in a second field is a second subfield, and subfield SF2 in the second field is a first subfield.

Thus, in the address period of subfield SF1 in the second field, differently from the address period of subfield SF1 in the first field, scan electrode 22 that undergoes an address operation first is scan electrode SCn in the n-th line. A scan pulse is applied sequentially from scan electrode SCn to scan electrode SC1.

In the address period of subfield SF2 in the second field, differently from the address period of subfield SF2 in the first field, scan electrode 22 that undergoes an address operation first is scan electrode SC1 in the first line. A scan pulse is applied sequentially from scan electrode SC1 to scan electrode SCn.

Hereinafter, in this exemplary embodiment, each of subfield SF3 subfield SF5, subfield SF7, and subfield SF9 in a second field is a second subfield. Each of subfield SF4, subfield SF6, subfield SF8, and subfield SF10 in the second field is a first subfield.

In this manner, in this exemplary embodiment, subfields occurring in the odd-numbered positions in a second field (subfield SF1, subfield SF3, subfield SF5, subfield SF7, and subfield SF9 in this exemplary embodiment) are second subfields. In the address periods, an address operation is performed in the discharge cells in the n-th line, the discharge cells in the (n−1)-th line, the discharge cells in the (n−2)-th line, . . . , the discharge cells in the second line, and the discharge cells in the first line in this order.

Subfields occurring in the even-numbered positions in the second field (subfield SF2, subfield SF4, subfield SF6, subfield SF8, and subfield SF10 in this exemplary embodiment) are first subfields. In the address periods, an address operation is performed in the discharge cells in the first line, the discharge cells in the second line, the discharge cells in the third line, . . . , the discharge cells in the (n−1)-th line, and the discharge cells in the n-th line in this order.

Thus, in the address periods of the subfields occurring in the odd-numbered positions in the second field, an address operation is performed on the respective discharge cells in the order same as that in the address periods of the subfields occurring in the even-numbered positions in the first field. In the address periods of the subfields occurring in the even-numbered positions in the second field, an address operation is performed on the respective discharge cells in the order same as that in the address periods of the subfields occurring in the odd-numbered positions in the first field.

Therefore, similarly to a first field, also in a second field, an address operation is performed in the respective discharge cells in the address periods of the respective subfields except subfield SF1 in the order opposite to that of address operations in the respective discharge cells in the address periods of the immediately preceding subfields. However, the order of a first subfield and a second subfield in the first field is opposite to that in the second field.

In the address periods of the respective subfields in the second field, the respective electrodes are applied with the driving voltages similar to those in the address periods of the respective subfields in the first field except for the order of address operations in the first field.

In the sustain periods and the erasing periods of the respective subfields in the second field, the respective electrodes are applied with the driving voltage waveforms similar to those in the sustain period and the erasing period of subfield SF1 in the first field except for the number of sustain pulses.

In this exemplary embodiment, an image is displayed on panel 10 such that a first field and a second field are generated so as to be repeated alternately.

In this exemplary embodiment, in the erasing period of each subfield in the first field and the second field, an erasing discharge occurs only in the discharge cells having undergone an address discharge in the address period of the subfield to which the erasing period belongs. No erasing discharge occurs in the discharge cells having undergone no address discharge. Therefore, in the discharge cells displaying black where no sustain discharge occurs (gradation value “0”), none of an initializing discharge, an address discharge, a sustain discharge, and an erasing discharge occur, and thus no light emission is caused by such a discharge.

In this exemplary embodiment, the examples of the values of voltages applied to the respective electrodes are as follows: voltage V1=−260 (V); voltage Vc=−145 (V); voltage Va=−280 (V); voltage Vs=200 (V); voltage Vr=200 (V); voltage Ve=20 (V); and voltage Vd=60 (V).

The specific numerical values of the voltages shown above are only examples. In the present invention, the respective voltage values are not limited to the above numerical values. Preferably, each voltage value is set optimally for the discharge characteristics of panel 10, the specifications of the plasma display apparatus, or the like.

The above subfield structure is only an example of this exemplary embodiment. The present invention is not limited to this subfield structure. Preferably, the number of subfields forming one field and the luminance weights of the respective subfields are set optimally for the characteristics of the panel, the specifications of the plasma display apparatus, or the like.

The above description of wall voltages shows wall voltage on each electrode on the assumption that the wall voltage in the space of a discharge cell is 0 (V), which is a reference electric potential. However, as is well known, what are important in considering wall voltage are a difference in wall voltage between the electrodes and a change in the wall voltage on each electrode.

Discharge start voltage VFds and discharge start voltage VFsd of panel 10 for use in this exemplary embodiment are measured by the method described below, and the values are as follows.

The discharge start voltages vary with phosphors. The inventor of the present invention has obtained the following measurement results of the discharge start voltages in panel 10. In a discharge cell applied with the red phosphor, discharge start voltage VFds is 200±10 (V) and discharge start voltage VFsd is 320±10 (V) between “data electrode 32 and scan electrode 22”.

In a discharge cell applied with the green phosphor, discharge start voltage VFds is 220±10 (V) and discharge start voltage VFsd is 350±10 (V) between “data electrode 32 and scan electrode 22”.

In a discharge cell applied with the blue phosphor, discharge start voltage VFds is 200±10 (V) and discharge start voltage VFsd is 330±10 (V) between “data electrode 32 and scan electrode 22”.

Discharge start voltage VFss between “scan electrode 22 and sustain electrode 23” is 250±10 (V) in a discharge cell applied with the red phosphor and a discharge cell applied with the blue phosphor, and is 280±10 (V) in a discharge cell applied with the green phosphor.

In this exemplary embodiment, since the low-side voltage of the sustain pulses is voltage 0 (V) and the voltage applied to data electrode 32 in the sustain period is voltage 0 (V), first voltage V1 is voltage 0 (V). Since the low-side voltage of the scan pulse is voltage Va and the low-side voltage of the address pulse is voltage 0 (V), third voltage V3 is voltage Va (−280 (V)).

Discharge start voltage VFds is higher in the discharge cells applied with the green phosphor than in the other discharge cells. The maximum value is voltage 230 (V) in consideration of variations. As described above, (Condition 1) is (V1−V3)≧VFds. Further,

(First voltage V1−Third voltage V3)=0−Va=280 (V) and (Maximum value of VFds)=230 (V)

That is,

(First voltage V1−Third voltage V3)>(Maximum value of VFds), which shows that (Condition 1) is satisfied in all the discharge cells.

Since the high-side voltage of the sustain pulses is voltage Vs and the voltage applied to data electrode 32 in the sustain period is voltage 0 (V), second voltage V2 is voltage Vs (200 (V)). Discharge start voltage VFsd is lower in the discharge cells applied with the red phosphor than in the other discharge cells. The minimum value is voltage 310 (V) in consideration of variations. Discharge start voltage VFds is lower in the discharge cells applied with the red phosphor or the blue phosphor than in the other discharge cells. The minimum value is voltage 190 (V) in consideration of variations. Therefore, the minimum value of the sum of discharge start voltage VFsd and discharge start voltage VFds is voltage 500 (V).

As described above, (Condition 2) is (V2−V3)<(VFds+VFsd). Further,

(Second voltage V2−Third voltage V3)=Vs−Va=(200+280) (V) and Minimum value of (VFds+VFsd)=500 (V).

### Thus, 480 (V)<500 (V). That is,

(Second voltage V2−Third voltage V3)<Minimum value of (VFds+VFsd), which shows also (Condition 2) is satisfied in all the discharge cells.

As obvious from the above voltages, scan electrode 22 is applied with a voltage ranging from low-side voltage Va of the scan pulse to high-side voltage Vs of the sustain pulses, inclusive. That is, scan electrode 22 is not applied with a voltage lower than low-side voltage Va of the scan pulse or a voltage exceeding high-side voltage Vs of the sustain pulses. Thus, a discharge cell having undergone no address discharge does not emit light.

As obvious from the above voltages, when voltage Va is set low so as to satisfy (Condition 1), absolute value |Va| of low-side voltage Va of the scan pulse is greater than absolute value |Vs| of high-side voltage Vs of the sustain pulses.

In this manner, in this exemplary embodiment, driving voltage waveforms applied to the respective electrodes, especially voltage Va of the scan pulse, are set so as to satisfy (Condition 1) and (Condition 2).

That is, in each erasing period, an erasing discharge is selectively caused only in the discharge cells having undergone an address discharge in the immediately preceding address period. Further, as described with reference to FIG. 5, the voltage obtained by subtracting third voltage V3 from first voltage V1 is equal to or higher than discharge start voltage VFds (Condition 1), and the voltage obtained by subtracting third voltage V3 from second voltage V2 does not exceed the sum of discharge start voltage VFds and discharge start voltage VFsd (Condition 2). With this setting, even when no forced initializing operation is performed, an address discharge can occur in a discharge cell where the address discharge is to be caused, and no address discharge can occur in a discharge cell where no address discharge is to be caused. That is, a stable address operation is performed. The reasons are considered as follows.

First, (Condition 1) is described. In order to cause an address discharge, a discharge needs to start between data electrode Dj and scan electrode SCi. In order to start a discharge by applying relatively low voltage Vd to data electrode Dj, a sufficient positive wall voltage needs to have accumulated on data electrode Dj such that a voltage substantially equal to discharge start voltage VFds is applied between data electrode Dj and scan electrode SCi when a scan pulse is applied to scan electrode SCi.

As described above, in this exemplary embodiment, no forced initializing operation is performed. Thus, in a discharge cell displaying black (gradation value “0”), none of an initializing discharge, an address discharge, a sustain discharge, and an erasing discharge occur. Thus, suitable control of the wall voltages is difficult, and the wall voltages in a discharge cell displaying black tend to be unstable. However, even in such a discharge cell, if a small amount of charged particles are present in the discharge space, the particles move to the respective electrodes and adhere to the wall of the discharge cell so as to alleviate the electric field inside the discharge space. Thus, wall voltages accumulate.

The wall voltages thus accumulated are described. In each sustain period, a large amount of charged particles are generated in a discharge cell undergoing a sustain discharge. It is considered that diffusion of these charged particles to the surrounding discharge cells supplies a small amount of charged particles to the inside of the surrounding discharge cells that undergo no sustain discharge.

In a discharge cell supplied with the charged particles, wall voltages are slowly accumulated on the electrodes by the voltage applied to each of scan electrode SCi, sustain electrode SUi, and data electrode Dj so as to reduce the voltage difference between the electrodes.

The voltage to which the wall voltage approaches without limit (settles finally) at this time is defined as a left wall voltage. The left voltage when sustain pulses are continuously applied alternately to scan electrode SCi and sustain electrode SUi is a voltage between the high-side voltage and the low-side voltage of the sustain pulses. Actually, driving voltage waveforms other than the sustain pulses are also applied to the discharge cell. Thus, it is considered that the left wall voltage of each discharge cell is substantially close to the low-side voltage of the sustain pulses.

The left wall voltage is considerably affected by the charging characteristic of the phosphor applied to the inside of a discharge cell. In this exemplary embodiment, the charging characteristic of the red phosphor is +20 (μC/g), that of the green phosphor is −30 (μC/g), and that of the blue phosphor is +10 (μC/g). Since only the green phosphor has a characteristic of being charged at negative electric potential as described above, the left wall voltage of a discharge cell applied with the green phosphor is lower than that of a discharge cell applied with the red phosphor or the blue phosphor.

Next, the voltage inside a discharge cell in the address period is described. On data electrode Dh of a discharge cell undergoing no address discharge and displaying black, wall voltage gradually accumulates toward a left wall voltage substantially equal to the low-side voltage of the sustain pulses or higher.

On the other hand, voltage Va of the scan pulse in this exemplary embodiment is a voltage that satisfies (Condition 1). Thus, a positive wall voltage sufficient to cause an address discharge accumulates on data electrode Dh, and an address discharge can occur in the discharge cell even without a forced initializing operation.

The wall voltage in a discharge cell displaying black slowly approaches to a left wall voltage without limit. When a voltage obtained by adding the wall voltage to the voltage between “data electrode 32 and scan electrode 22” approaches to the discharge start voltage in the erasing period, dark current (current flowing without a discharge) flows, and the wall voltage on data electrode Dh decreases. The dark current that flows at this time works as priming particles that help occurrence of an address discharge. Thus, even in a discharge cell having displayed black, a stable address discharge is considered to occur without a long discharge delay time.

As described above, in this exemplary embodiment, each voltage value is set such that the drive voltage applied to each electrode satisfies (Condition 1). Especially, voltage Va of the scan pulse in each address period is set low so as to satisfy (Condition 1). Thereby, even without a forced initializing operation before the address period, the wall voltages necessary for the address discharge can accumulate in discharge cells. Further, dark current working as priming particles for causing a stable address discharge can be generated in the discharge cells.

Next, (Condition 2) is described. If voltage Va of the scan pulse is too low, a sustain discharge occurs even in a discharge cell where no address operation is performed and no sustain discharge is to be caused, when voltage Vs of the sustain pulses is applied to scan electrode 22 in the sustain period. In order to suppress this false discharge, each voltage needs to be set such that the voltage between “data electrode 32 and scan electrode 22” is equal to or lower than discharge start voltage VFsd when voltage Vs of the sustain pulses is applied. This condition is (Condition 2).

In this manner, in this exemplary embodiment, the driving voltage waveforms are set such that (Condition 1) and (Condition 2) are satisfied in all the discharge cells. Thus, even when a forced initializing operation is omitted, a stable address discharge can occur. This allows display of an image without causing light emission unrelated to gradation display. That is, in this exemplary embodiment, a stable address operation is performed without a forced initializing operation, luminance of black level is suppressed, and thereby an image of high contrast can be displayed on panel 10.

In this exemplary embodiment, an image is displayed on panel 10 in the following manner. A first subfield and a second subfield where the order of application of scan pulses to respective electrodes 22 in the address periods is opposite to each other are generated alternately in each field. Further, a first field and a second field where the order of occurrence of the first subfield and the second subfield is different from each other are generated alternately. Hereinafter, a description is provided for the reason why panel 10 is driven such that the respective fields are generated in this manner.

In panel 10, as shown in FIG. 2, scan electrode 22 disposed at the top end (one end) is scan electrode SC1, and scan electrode 22 disposed at the bottom end (the other end) is scan electrode SCn. The number sequentially increases from scan electrode SC1 toward scan electrode SCn (scan electrode SC1, scan electrode SC2, scan electrode SC3, . . . , scan electrode SC(n−1), and scan electrode SCn).

Hereinafter, consideration is made on the operation when an image signal for displaying black in the entire image display area of panel 10 switches to an image signal for displaying white in the entire image display area. (The former image signal causes neither an address operation nor a sustain discharge in all the discharge cells, hereinafter being referred to as “entire black image signal. The latter image signal causes an address operation in all the discharge cells, hereinafter being referred to as “entire white image signal.)

In this exemplary embodiment, as described above, in a discharge cell displaying black, none of an initializing discharge, an address discharge, and a sustain discharge occur. In a discharge cell undergoing no discharge, no priming particles are generated and thus the priming particles are insufficient. The insufficient priming particles lengthen the discharge delay time and destabilize the occurrence of discharge.

When an address operation is performed in a discharge cell having insufficient priming particles, the address discharge is unstable and may not occur in some cases. Therefore, when an entire black image signal switches to an entire white image signal, the address operation can fail in a large number of discharge cells.

In contrast, in a discharge cell having undergone an address discharge, priming particles are generated, and thus a part of the priming particles move to the discharge cells adjacent to the discharge cell through the gaps between the discharge cells. Therefore, this phenomenon is substantially equal to supplying the priming particles from the discharge cell having undergone an address discharge to its adjacent discharge cells. In the discharge cells supplied with the priming particles, a more stable address discharge can occur in comparison with the state where the priming particles are insufficient.

Here, consideration is made on the case where a scan pulse is applied to respective scan electrodes 22 always in the same order in the address periods of all the subfields. For example, consideration is made on the case where an address operation similar to that in the address period of a first subfield is performed in the address periods of all the subfields. In this case, in the address periods of all the subfields, a scan pulse is applied sequentially from scan electrode SC1 disposed at the top end to scan electrode SCn disposed at the bottom end of panel 10.

When an address discharge occurs in any discharge cell at the changeover from an entire black image signal to an entire white image signal, as described above, priming particles are supplied to the discharge cells adjacent to the discharge cell. Since an address operation is performed from the top end to the bottom end of panel 10 in the above condition, the electrode to be applied with a scan pulse next to scan electrode SCi, to which the discharge cell having undergone the address discharge belongs, is scan electrode SCi+1, which is directly under scan electrode SCi.

That is, a line directly under the line to which a discharge cell having undergone an address operation belongs undergoes the address operation next to the line. Thus, the priming particles are supplied from the discharge cell having undergone an address discharge to its adjacent discharge cells in the directly upper, obliquely upper, and directly lateral directions, after these discharge cells have undergone the address operation. In contrast, to the adjacent discharge cells in the directly lower and obliquely lower directions, the priming particles are supplied from the discharge cell having undergone the address discharge before these discharge cells undergo the address operation. Therefore, in the discharge cells adjacent to the discharge cell having undergone the address discharge in the directly lower and obliquely lower directions, a relatively stable address discharge can occur with the supplied priming particles.

Because this phenomenon occurs as a chain reaction, when an address discharge occurs in any discharge cell at the changeover from an entire black image signal to an entire white image signal, a relatively stable address discharge occurs one after another in the discharge cells disposed in the directly lower and obliquely lower directions of the discharge cell. Once an address discharge occurs, a sustain discharge occurs in the immediately succeeding sustain period and the priming particles are generated in the discharge cells. Thus, a stable address discharge occurs also in the subfields thereafter.

In contrast, in the discharge cells other than the above discharge cells, an address operation is performed with insufficient priming particles.

Insufficient priming particles destabilize the address discharge. This can mean that an address discharge occurs with a probability lower than that in the case where a stable address discharge occurs. This means that the probability that an address discharge occurs is not “0”, and repeated address operations can cause an address discharge even in a discharge cell having insufficient priming particles. As described above, in the discharge cells disposed in the directly lower and obliquely lower directions of the discharge cell having undergone the address discharge, a stable address discharge occurs.

Therefore, when panel 10 is driven such that an address operation similar to that in the address period of a first subfield is performed in the address periods of all the subfields, the changeover from an entire black image signal to an entire white image signal causes display in the following order. White is displayed in the lower portion of the image display area of panel 10 first, thereafter the region displaying white spreads from the lower portion to the upper portion of the image display area, and finally white is displayed in the entire image display area.

In contrast, in the structure where panel 10 is driven such that an address operation similar to that in the address period of a second subfield is performed in the address periods of all the subfields, the changeover from an entire black image signal to an entire white image signal causes display in the following order. Opposite to the above phenomenon, white is displayed in the upper portion of the image display area of panel 10 first, thereafter the region displaying white spreads from the upper portion to the lower portion of the image display area, and finally white is displayed in the entire image display area.

In either case, it is expected that it takes a certain period of time after the changeover from an entire black image signal to an entire white image signal before actual display of white in the entire image display area. The inventor of the present invention has experimentally verified that it takes a time period of approximately 10 seconds to 20 seconds after an entire black image signal is displayed for approximately five minutes and switched to an entire white image signal before white is actually displayed in the entire image display area.

However, in this exemplary embodiment, panel 10 is driven such that a first subfield and a second subfield are generated alternately. Therefore, when an address discharge occurs in any discharge cell at the changeover from an entire black image signal to an entire white image signal in the first subfield, the discharge cells where a stable address discharge occurs spread one after another in the directly lower and obliquely lower directions of the discharge cell. In the succeeding second subfield, the discharge cells where a stable address discharge occurs spread one after another from the discharge cells having undergone an address discharge in the first subfield as starting points to the discharge cells in the directly upper and obliquely upper directions of the discharge cells.

In the structure of this exemplary embodiment, panel 10 is driven such that a first subfield and a second subfield are generated alternately. This structure can reduce the time taken after the changeover from an entire black image signal to an entire white image signal before actual display of white in the entire image display area in comparison with the structure where an address operation is performed always in the same order in the address periods of all the subfields. The inventor of the present invention has experimentally verified that in the structure of this exemplary embodiment, it takes only an average time period substantially equal to one field after an entire black image signal is displayed for approximately five minutes and switched to an entire white image signal before white is actually displayed in the entire image display area.

Further, in this exemplary embodiment, panel 10 is driven such that a first field and a second field are generated alternately. Therefore, the subfield as a first subfield and the subfield as a second subfield are generated in the reverse order in the first field and the second field. Thus, for instance, even when an entire black image signal switches to an image signal for lighting all the discharge cells only in subfield SF1, an address operation can be performed such that a first subfield and a second subfield are generated alternately. This structure can rapidly increase the number of discharge cells where a stable address discharge occurs in comparison with the structure where panel 10 is driven such that only either one of a first field and a second field is generated.

Discharge start voltage VFsd and discharge start voltage VFds, and wall voltages can be measured in the method described below, for example, in a simple manner.

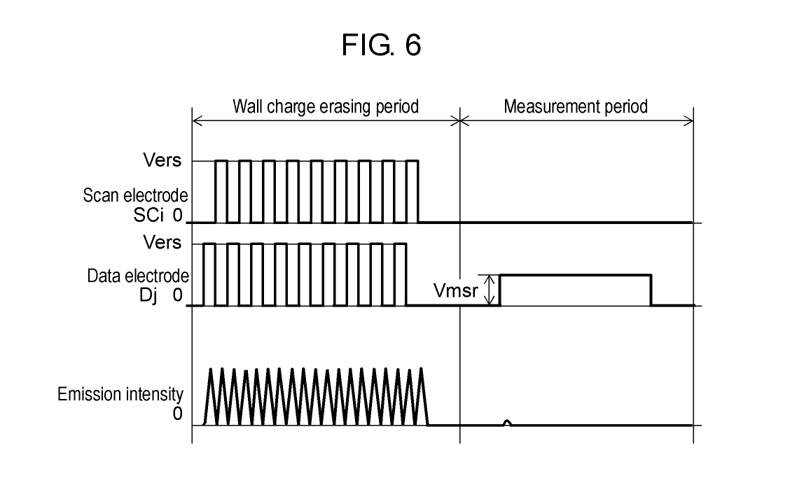

FIG. 6 is a diagram showing an example of a method for measuring a discharge start voltage in a simple manner.

First, the operation of erasing wall charge is performed. Specifically, as shown in the wall charge erasing period of FIG. 6, pulse-like voltage Vers sufficiently higher than the expected discharge start voltage is alternately applied between the electrodes to be measured, e.g. data electrode 32 and scan electrode 22.

Next, a discharge start voltage is observed. Specifically, as shown in the measurement period of FIG. 6, pulse-like voltage Vmsr lower than the expected discharge start voltage is applied to one of the electrodes (data electrode 32, for example). Then, the light emission caused by the discharge at this time is detected using a light sensor, such as a photomultiplier.

When no light emission is observed, no discharge has occurred. Then, after the operation of erasing wall charge in the wall charge erasing period is performed again, pulse-like voltage Vmsr whose absolute value is higher than the previous value is applied to the same electrode (data electrode 32, for example), and a light emission is observed.

This operation is repeated until a light emission is observed. The absolute value of minimum voltage Vmsr obtained when a light emission is observed in the measurement period is a discharge start voltage.

At this time, when voltage Vmsr applied in the measurement period is a positive voltage, discharge start voltage VFds of a discharge between data electrode 32 as an anode and scan electrode 22 as a cathode can be measured. When voltage Vmsr applied in the measurement period is a negative voltage, discharge start voltage VFsd of a discharge between data electrode 32 as a cathode and scan electrode 22 as an anode can be measured.

When a discharge start voltage is known, wall voltage in a discharge cell having accumulated wall voltage can be obtained in the following manner. A voltage at which a discharge starts is measured, and the difference between that voltage value and the discharge start voltage measured in advance is calculated as the wall voltage.

Alternatively, discharge start voltage VFsd, discharge start voltage VFds, and wall voltage can be measured by a method described in IEEE TRANSACTIONS ON ELECTRON DEVICES, VOL ED-24, NO. 7, JULY, 1977 “Measurement of a Plasma in the AC Plasma Display Panel Using RF Capacitance and Microwave Techniques”, for example.

Next, a driver circuit for driving panel 10 is described.

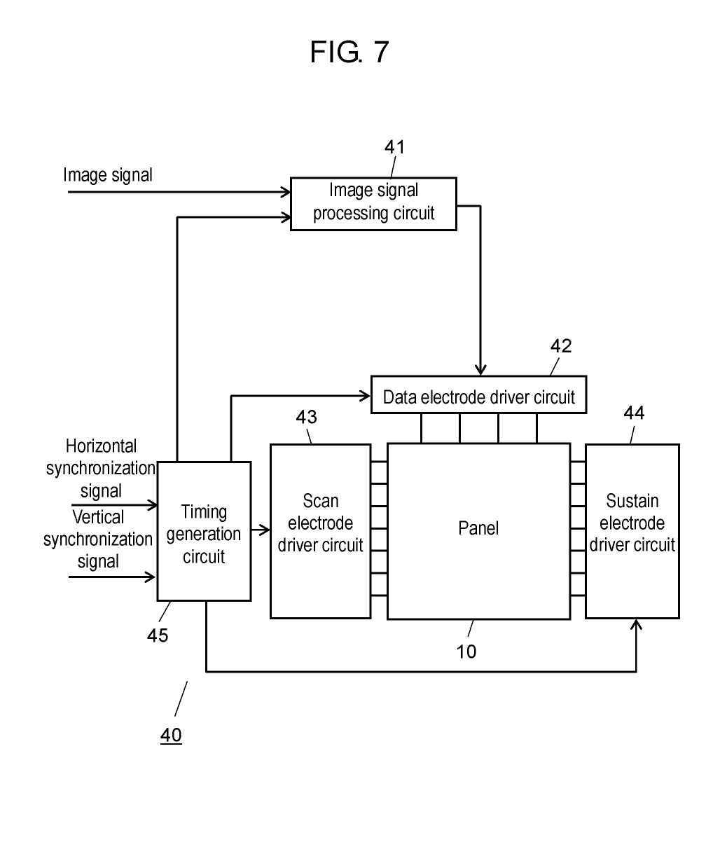

FIG. 7 is a circuit block diagram of plasma display apparatus 40 in accordance with the first exemplary embodiment of the present invention.

Plasma display apparatus 40 includes the following elements:

panel 10 having a plurality of discharge cells, each having scan electrode 22, sustain electrode 23, and data electrode 32; and

a driver circuit for driving panel 10 by generating driving voltage waveforms shown in FIG. 3 and FIG. 4 and applying the waveforms to the respective electrodes of panel 10 such that one field is formed of a plurality of subfields, each having an address period, a sustain period, and an erasing period.

The driver circuit has image signal processing circuit 41, data electrode driver circuit 42, scan electrode driver circuit 43, sustain electrode driver circuit 44, timing generation circuit 45, and electric power supply circuits (not shown) for supplying electric power necessary for each circuit block.

Image signal processing circuit 41 sets a gradation value to each discharge cell, based on an input image signal. The image signal processing circuit converts the gradation value into image data representing light emission and no light emission (data where light emission and no light emission corresponds to digital signals “1” and “0”, respectively) in each subfield. That is, image signal processing circuit 41 convers an image signal in each field into image data representing light emission and no light emission in each subfield.

The image signals input to image signal processing circuit 41 are red primary color signal sigR, green primary color signal sigG, and blue primary color signal sigB. Image signal processing circuit 41 sets the R, G, and B gradation values to the respective discharge cells, based on primary color signal sigR, primary color signal sigG, and primary color signal sigB. When the input image signal includes a luminance signal (Y signal) and a chroma signal (C signal, R-Y signal and B-Y signal, u signal and v signal, or the like), image signal processing circuit 41 calculates primary color signal sigR, primary color signal sigG, and primary color signal sigB, based on the luminance signal and the chroma signal, and thereafter sets the R, G, and B gradation values (gradation values represented in one field) to the respective discharge cells. Then, the R, G, and B gradation values set to the respective discharge cells are converted into image data representing light emission and no light emission in each subfield.

Based on a horizontal synchronization signal and vertical synchronization signal, timing generation circuit 45 generates various timing signals for controlling the operation of each circuit block. Then, the timing generation circuit supplies the generated timing signals to each circuit block (data electrode driver circuit 42, scan electrode driver circuit 43, sustain electrode driver circuit 44, image signal processing circuit 41, or the like).

Scan electrode driver circuit 43 has a ramp waveform voltage generation circuit, a sustain pulse generation circuit, and a scan pulse generation circuit (not shown in FIG. 7). The scan electrode driver circuit generates driving voltage waveforms shown in FIG. 3 and FIG. 4, in response to timing signals supplied from timing generation circuit 45, and applies the waveforms to each of scan electrode SC1-scan electrode SCn. In response to a timing signal, the ramp waveform voltage generation circuit generates an up-ramp waveform voltage and a down-ramp waveform voltage to be applied to scan electrode SC1-scan electrode SCn in the erasing periods. In response to a timing signal, the sustain pulse generation circuit generates sustain pulses to be applied to scan electrode SC1-scan electrode SCn in the sustain periods. The scan pulse generation circuit has a plurality of scan electrode driver ICs (scan ICs). In response to a timing signal, the scan pulse generation circuit generates a scan pulse to be applied to scan electrode SC1-scan electrode SCn in the address periods.

Sustain electrode driver circuit 44 has a sustain pulse generation circuit and a circuit for generating voltage Ve (not shown in FIG. 7). In response to timing signals supplied from timing generation circuit 45, the sustain electrode driver circuit generates driving voltage waveforms shown in FIG. 3 and FIG. 4, and applies the waveforms to each of sustain electrode SU1-sustain electrode SUn. In the sustain periods, in response to a timing signal, sustain pulses are generated. In the erasing periods and the address periods, in response to a timing signal, voltage Ve is generated. The sustain electrode driver circuit applies these pulses and voltage to sustain electrode SU1-sustain electrode SUn.

Data electrode driver circuit 42 converts data that forms image data based on an image signal in each subfield into a signal corresponding to each of data electrode D1-data electrode Dm. Then, in response to the above signal, and a timing signal supplied from timing generation circuit 45, the data electrode driver circuit drives each of data electrode D1-data electrode Dm. In the address periods, the data electrode driver circuit generates an address pulse, and applies the address pulse to each of data electrode D1-data electrode Dm.

Next, scan electrode driver circuit 43 is detailed.

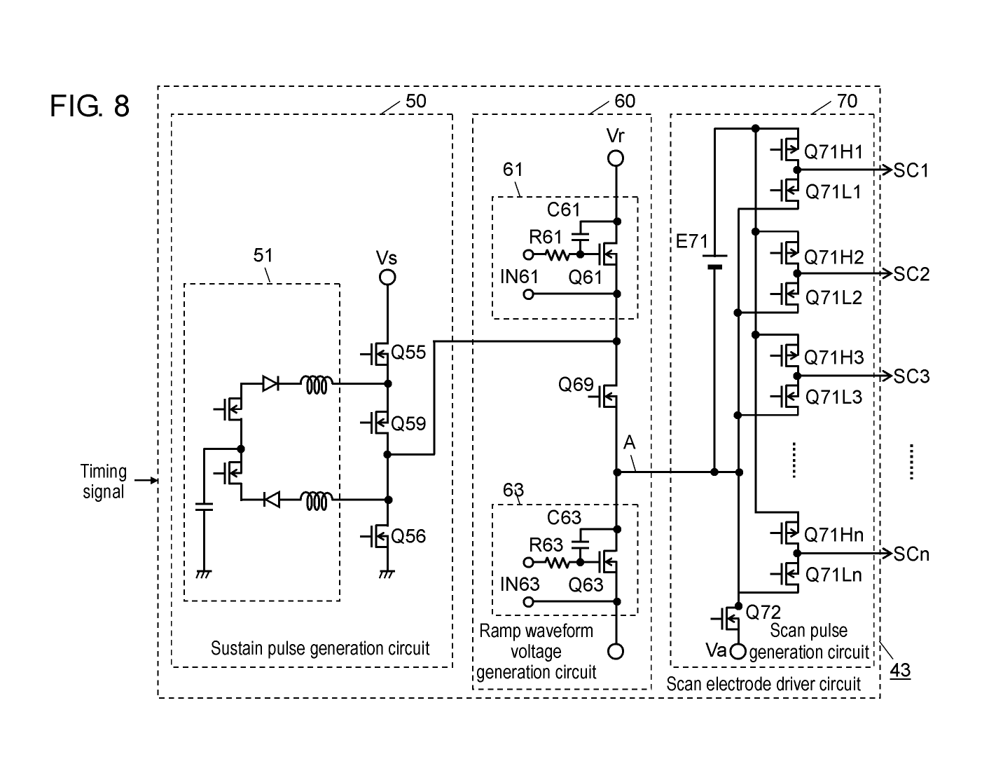

FIG. 8 is a circuit diagram schematically showing scan electrode driver circuit 43 of plasma display apparatus 40 in accordance with the first exemplary embodiment of the present invention. Scan electrode driver circuit 43 has sustain pulse generation circuit 50, ramp waveform voltage generation circuit 60, and scan pulse generation circuit 70, and operates the respective circuits in response to timing signals. In the diagram, the detailed signal paths for control signals (timing signals supplied from timing generation circuit 45) input to each circuit are omitted.

Sustain pulse generation circuit 50 includes power recovery circuit 51, switching element Q55, switching element Q56, and switching element Q59. The sustain pulse generation circuit generates sustain pulses to be applied to scan electrode SC1-scan electrode SCn. Power recovery circuit 51 uses LC resonance so as to recover electric power stored in panel 10 from panel 10, reuses the recovered electric power as the electric power in driving scan electrode SC1-scan electrode SCn, and supplies electric power to panel 10 again. Switching element Q55 clamps scan electrode SC1-scan electrode SCn to voltage Vs, and switching element Q56 clamps scan electrode SC1-scan electrode SCn to voltage 0 (V). Switching element Q59 is a separation switch and provided so as to prevent backflow of electric current via a parasitic diode, for example, in the switching elements constituting scan electrode driver circuit 43.

Scan pulse generation circuit 70 has the following elements:

switching element Q71H1-switching element Q71Hn, switching element Q71L1-switching element Q71Ln, and switching element Q72;

an electric power supply for negative voltage Va; and

electric power supply E71 for generating voltage VC.

The scan pulse generation circuit generates voltage Vc (Vc=VC+Va) by superimposing voltage VC on the reference electric potential of scan pulse generation circuit 70 (the electric potential of node A in FIG. 8), and applying voltage Va or voltage Vc to scan electrode SC1-scan electrode SCn while these voltages are switched. For instance, when voltage Va=−280 (V) and voltage VC=135 (V), voltage Vc=−145 (V). Then, the scan pulse generation circuit applies a scan pulse to each of scan electrode SC1-scan electrode SCn at timings shown in FIG. 3 and FIG. 4. In the sustain periods, scan pulse generation circuit 70 outputs the output voltage of sustain pulse generation circuit 50 without any change. That is, the voltage at node A is output to scan electrode SC1-scan electrode SCn.

Ramp waveform voltage generation circuit 60 includes Miller integration circuit 61 and Miller integration circuit 63, and generates an up-ramp waveform voltage and a down-ramp waveform voltage shown in FIG. 3 and FIG. 4.

Miller integration circuit 61 has transistor Q61, capacitor C61, and resistor R61. When a constant voltage is applied to input terminal IN61 (a constant voltage difference is given to two circles illustrated as input terminal IN61), the Miller integration circuit generates an up-ramp waveform voltage that gently rises toward voltage Vr. Miller integration circuit 63 has transistor Q63, capacitor C63, and resistor R63. When a constant voltage is applied to input terminal IN63 (a constant voltage difference is given to two circles illustrated as input terminal IN63), the Miller integration circuit generates a down-ramp waveform voltage that gently falls toward voltage V1. Switching element Q69 is a separation switch, and provided so as to prevent backflow of electric current via a parasitic diode, for example, in the switching elements constituting scan electrode driver circuit 43.

These switching elements and transistors can be formed of generally known semiconductor devices, such as a metal-oxide-semiconductor field-effect transistor (MOSFET) and an insulated gate bipolar transistor (IGBT). These switching elements and transistors are controlled by the timing signals corresponding to the switching elements and transistors that are generated in timing generation circuit 45.

Next, sustain electrode driver circuit 44 is detailed.

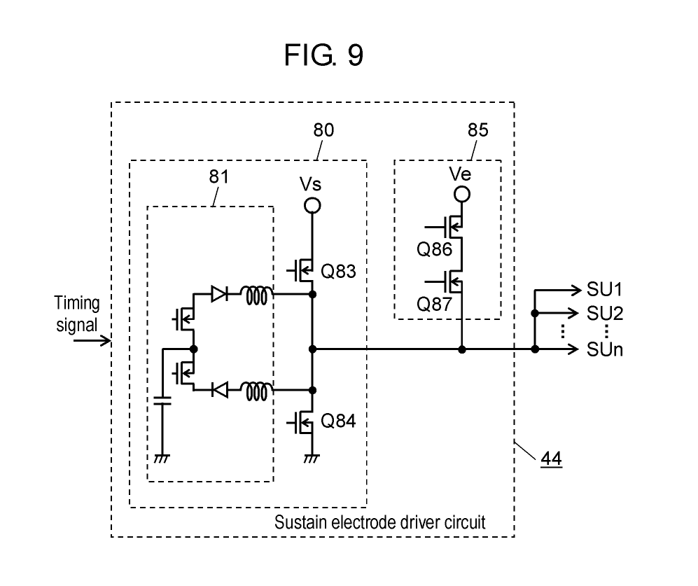

FIG. 9 is a circuit diagram schematically showing sustain electrode driver circuit 44 of plasma display apparatus 40 in accordance with the first exemplary embodiment of the present invention. Sustain electrode driver circuit 44 has sustain pulse generation circuit 80 and constant voltage generation circuit 85, and operates each circuit in response to timing signals. In the diagram, the detailed signal paths for control signals (timing signals supplied from timing generation circuit 45) input to each circuit are omitted.

Sustain pulse generation circuit 80 includes power recovery circuit 81, switching element Q83, and switching element Q84. The sustain pulse generation circuit generates sustain pulses to be applied to sustain electrode SU1-sustain electrode SUn. Power recovery circuit 81 uses LC resonance so as to recover electric power stored in panel 10 from panel 10, reuses the recovered electric power as the electric power in driving sustain electrode SU1-sustain electrode SUn, and supplies electric power to panel 10 again. Switching element Q83 clamps sustain electrode SU1-sustain electrode SUn to voltage Vs, and switching element Q84 clamps sustain electrode SU1-sustain electrode SUn to voltage 0 (V).

Constant voltage generation circuit 85 includes switching element Q86 and switching element Q87, and applies voltage Ve to sustain electrode SU1-sustain electrode SUn.

These switching elements also can be formed of generally known semiconductor devices, such as a MOSFET and an IGBT. These switching elements are also controlled by the timing signals corresponding to the switching elements that are generated in timing generation circuit 45.

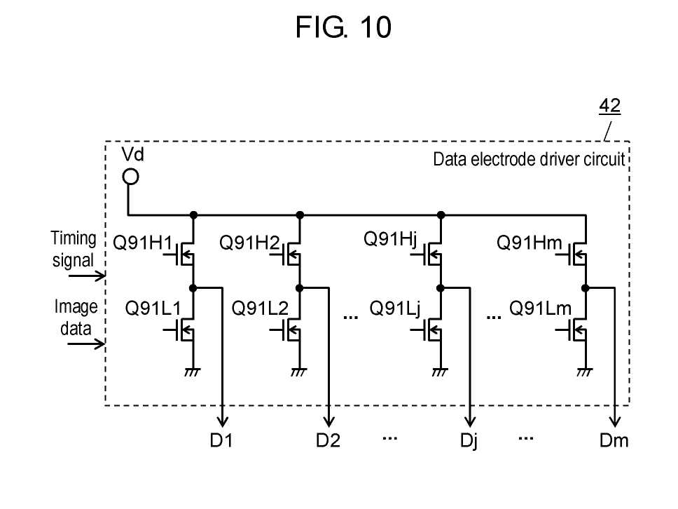

FIG. 10 is a circuit diagram schematically showing data electrode driver circuit 42 of plasma display apparatus 40 in accordance with the first exemplary embodiment of the present invention. In the diagram, the detailed signal paths for control signals (timing signals supplied from timing generation circuit 45) input to each circuit are omitted.

Data electrode driver circuit 42 includes switching element Q91H1-switching element Q91Hm and switching element Q91L1-switching element Q91Lm. Based on image data (the details of the image data being omitted in the diagram), the following operations are performed. By setting switching element Q91Lj to ON, voltage 0 (V) is applied to data electrode Dj. By setting switching element Q91Hj to ON, voltage Vd is applied to data electrode Dj.

In this exemplary embodiment, the driving voltage waveforms shown in FIG. 3 and FIG. 4 can be generated with these driver circuits, for example. However, the driver circuits shown in FIG. 7, FIG. 8, FIG. 9, and FIG. 10 are only examples, and the driver circuits of the present invention are not limited to these circuit configurations.

As shown above, in this exemplary embodiment, a scan pulse that satisfies the above conditions is generated and applied to scan electrodes 22 in the address periods. Thereby, a stable address operation can be performed without a forced initializing operation. This can suppress luminance of black level, thereby displaying an image of high contrast on panel 10.

In this exemplary embodiment, subfield SF1 in a first field is a first subfield, and subfield SF1 in a second field is a second subfield. However, the present invention is not limited to this structure. For example, subfield SF1 in a first field may be a second subfield, and subfield SF1 in a second field may be a first subfield.

### Second Exemplary Embodiment

Next, a description is provided for driving voltage waveforms in the second exemplary embodiment of the present invention with reference to the accompanying drawings.

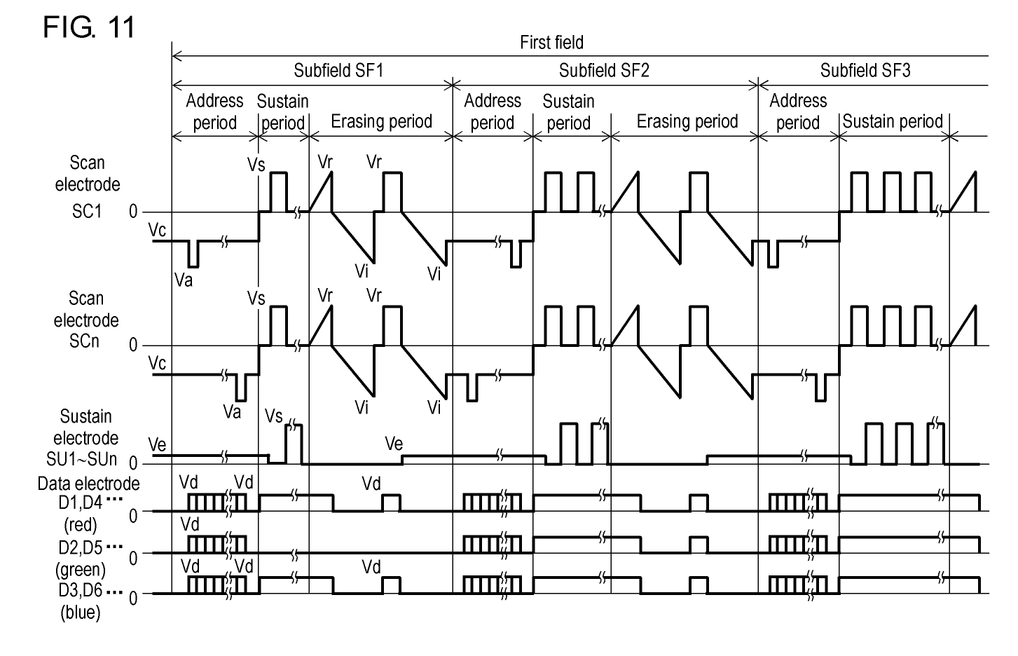

FIG. 11 is a chart schematically showing driving voltage waveforms in a first field applied to the respective electrodes of the panel for use in the plasma display apparatus in accordance with the second exemplary embodiment of the present invention.

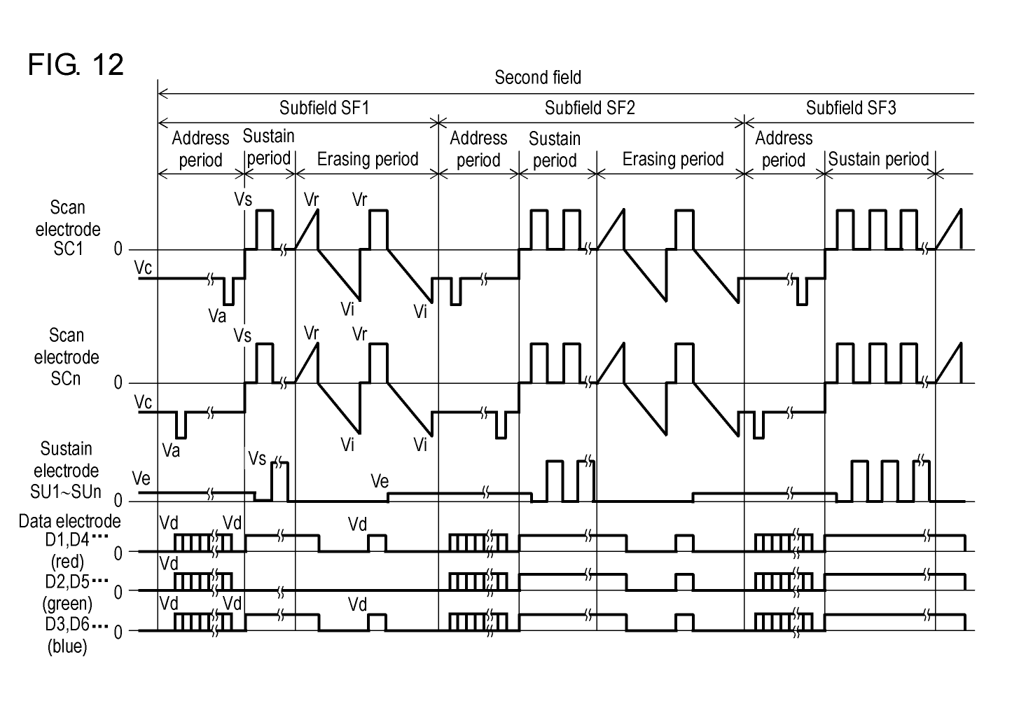

FIG. 12 is a chart schematically showing driving voltage waveforms in a second field applied to the respective electrodes of the panel for use in the plasma display apparatus in accordance with the second exemplary embodiment of the present invention.

FIG. 11 and FIG. 12 show driving voltage waveforms applied to the following electrodes: scan electrode SC1 to undergo an address operation first in the address periods; scan electrode SCn to undergo an address operation last in the address periods; sustain electrode SU1-sustain electrode SUn; data electrode Dp of a discharge cell applied with the red phosphor (p=3×q−2 where q is an integer except 0 equal to or smaller than m/3, e.g. data electrode D1 and data electrode D4); data electrode Dp+1 of a discharge cell applied with the green phosphor (e.g. data electrode D2 and data electrode D5); and data electrode Dp+2 of a discharge cell applied with the blue phosphor (e.g. data electrode D3 and data electrode D6). Scan electrode SCi, sustain electrode SUi, and data electrode Dk in the following description are the electrodes selected from the respective electrodes, based on image data (data representing light emission and no light emission in each subfield).

FIG. 11 and FIG. 12 mainly show driving voltage waveforms in three subfields, i.e. subfield SF1, subfield SF2, and subfield SF3.

In the second exemplary embodiment, the number of subfields forming one field, the luminance weights allocated to the respective subfields, the structure of the respective subfields, or the like is identical with that in the first exemplary embodiment. Thus, the description is omitted.

In the second exemplary embodiment, a first subfield and a second subfield are generated so as to be repeated alternately in each field. In the first subfield and the second subfield in the second exemplary embodiment, the address operation same as that in the first subfield and the second subfield in the first exemplary embodiment is performed.

Further, in the second exemplary embodiment, an image is displayed on panel 10 such that a first field and a second field are repeated alternately. The order of a first subfield and a second subfield generated in a first field and a second field in the second exemplary embodiment is the same as that in a first field and a second field in the first exemplary embodiment.

First, a first field in this exemplary embodiment is described with reference to FIG. 11.

Subfield SF1 in the first field is a first subfield.

As shown in FIG. 11, in the address period of subfield SF1 in the first field, voltage 0 (V) is applied to data electrode D1-data electrode Dm, voltage Ve is applied to sustain electrode SU1-sustain electrode SUn, and voltage Vc is applied to scan electrode SC1-scan electrode SCn.

Next, a negative scan pulse at voltage Va is applied to scan electrode SC1 in the first line, which undergoes an address operation first. Further, an address pulse (data pulse) at positive voltage Vd is applied to data electrode Dk of a discharge cell to be lit in the first line among data electrode D1-data electrode Dm.

At this time, voltage Va is set so as to satisfy (Condition 1) and (Condition 2) in a similar manner to that in the first exemplary embodiment.

With the application of the pulses, an address discharge occurs between data electrode Dk and scan electrode SC1, and between sustain electrode SU1 and scan electrode SC1. Positive wall voltage accumulates on scan electrode SC1, and negative wall voltage accumulates on sustain electrode SU1. Negative wall voltage also accumulates on data electrode Dk. In this manner, an address operation is performed so as to cause an address discharge in the discharge cells to be lit in the first line and accumulate wall voltages on the respective electrodes.

In contrast, the voltage in the intersecting part of scan electrode SC1 and data electrode Dh applied with no address pulse does not exceed discharge start voltage VFds, and thus no address discharge occurs.

Next, a scan pulse at voltage Va is applied to scan electrode SC2 in the second line and an address pulse at voltage Vd is applied to data electrode Dk corresponding to a discharge cell to be lit in the second line. In this manner, an address operation is performed in the discharge cells in the second line.

The similar address operation is performed on scan electrode SC3 in the third line, scan electrode SC4 in the fourth line, . . . , scan electrode SC(n−1) in the (n−1)-th line, and scan electrode SCn in the n-th line in this order sequentially from the discharge cells in the third line to the discharge cells in the n-th line. Thus, the address period of subfield SF1 is completed.

Next, a description is provided for the sustain period of subfield SF1 in this exemplary embodiment.

In the sustain period of subfield SF1, the following voltages are applied to the respective data electrodes. Voltage Vd is applied to data electrode Dp of a discharge cell applied with the red phosphor (e.g. data electrode D1, data electrode D4, and data electrode D7) and to data electrode Dp+2 of a discharge cell applied with the blue phosphor (e.g. data electrode D3, data electrode D6, and data electrode D9). Voltage 0 (V) is applied to data electrode Dp+1 of a discharge cell applied with the green phosphor (e.g. data electrode D2, data electrode D5, and data electrode D8).

Then, voltage 0 (V) is applied to sustain electrode SU1-sustain electrode SUn, and a sustain pulse at positive voltage Vs is applied to scan electrode SC1-scan electrode SCn.

With the application of the sustain pulse, in the discharge cells having undergone the address discharge, a sustain discharge occurs between scan electrode SCi and sustain electrode SUi. Ultraviolet rays generated by this discharge cause phosphor layers 35 to emit light.

With this sustain discharge, negative wall voltage accumulates on scan electrode SCi, and positive wall voltage accumulates on sustain electrode SUi. Positive wall voltage also accumulates on data electrode Dk. In contrast, in the discharge cells having undergone no address discharge in the address period, no sustain discharge occurs and the wall voltages having been generated are maintained.

Subsequently, voltage 0 (V) is applied to scan electrode SC1-scan electrode SCn, and a sustain pulse at voltage Vs is applied to sustain electrode SU1-sustain electrode SUn. In the discharge cells having undergone the sustain discharge immediately before this voltage application, a sustain discharge occurs between sustain electrode SUi and scan electrode SCi again, and phosphor layers 35 in the discharge cells having undergone the sustain discharge emit light. Negative wall voltage accumulates on sustain electrode SUi, and positive wall voltage accumulates on scan electrode SCi.

Similarly, sustain pulses equal in number to the luminance weight multiplied by a predetermined luminance magnification are applied alternately to scan electrode SC1-scan electrode SCn and sustain electrode SU1-sustain electrode SUn. A sustain discharge is continuously caused in the discharge cells having undergone the address discharge in the address period.

Thus, the sustain operation in the sustain period of subfield SF1 is completed.

Next, a description is provided for the erasing period of subfield SF1 in this exemplary embodiment.

In the erasing period of subfield SF1, subsequently to the sustain period, the following voltages are applied to the respective data electrodes. Voltage Vd is applied to data electrode Dp of a discharge cell applied with the red phosphor (e.g. data electrode D1, data electrode D4, and data electrode D7), and to data electrode Dp+2 of a discharge cell applied with the blue phosphor (e.g. data electrode D3, data electrode D6, and data electrode D9). Voltage 0 (V) is applied to data electrode Dp+1 of a discharge cell applied with the green phosphor (e.g. data electrode D2, data electrode D5, and data electrode D8).

Next, an up-ramp waveform voltage gently rising from voltage 0 (V) toward voltage Vr is applied to scan electrode SC1-scan electrode SCn while a fourth voltage of voltage 0 (V) is applied to sustain electrode SU1-sustain electrode SUn.

Also in this exemplary embodiment, voltage Vr and voltage Vs are set to an equal voltage value. However, voltage Vr and voltage Vs may have different voltage values.

While the up-ramp waveform voltage applied to scan electrode SC1-scan electrode SCn is rising above the discharge start voltage, a first discharge occurs in the discharge cells having undergone the sustain discharge in the sustain period of the subfield (the discharge cells having undergone the address discharge in the subfield where the sustain period is omitted). This discharge is a first discharge between scan electrode SCi as an anode and sustain electrode SUi as a cathode, and is a weak discharge. The charged particles generated by this erasing discharge accumulate on sustain electrode SUi and scan electrode SCi as wall charge so as to reduce the voltage difference between sustain electrode SUi and scan electrode SCi. This phenomenon reduces the wall voltages on scan electrode SCi and sustain electrode SUi while the positive wall voltage is left on data electrode Dk, and thus erases unnecessary wall charge in the discharge cell.

After the voltage applied to scan electrode SC1-scan electrode SCn has reached voltage Vr, the voltage applied to scan electrode SC1-scan electrode SCn is lowered to voltage 0 (V).

Next, voltage 0 (V) is applied to all data electrode D1-data electrode Dm. While voltage 0 (V) is applied to sustain electrode SU1-sustain electrode SUn, a down-ramp waveform voltage gently falling from voltage 0 (V) to voltage V1 is applied to scan electrode SC1-scan electrode SCn.

Thus, a second discharge occurs in the discharge cells having undergone the weak discharge. This discharge is a first discharge between scan electrode SCi as a cathode and data electrode Dk as an anode, and is a weak discharge.

Thereafter, while voltage 0 (V) is applied to data electrode Dp+1 of a discharge cell applied with the green phosphor (e.g. data electrode D2, data electrode D5, and data electrode D8), voltage Vd is applied to data electrode Dp of a discharge cell applied with the red phosphor (e.g. data electrode D1, data electrode D4, and data electrode D7), and data electrode Dp+2 of a discharge cell applied with the blue phosphor (e.g. data electrode D3, data electrode D6, and data electrode D9). At the same time, a rectangular waveform voltage at voltage Vr is applied to scan electrode SC1-scan electrode SCn.

Thus, a third discharge occurs in the discharge cells having undergone the weak discharge. This discharge is a second discharge between scan electrode SCi as an anode and sustain electrode SUi as a cathode, and is a weak discharge.

Next, voltage 0 (V) is applied to all data electrode D1-data electrode Dm. Voltage Ve is applied to sustain electrode SU1-sustain electrode SUn as a fifth voltage higher than the fourth voltage, and a down-ramp waveform voltage gently falling from voltage 0 (V) to voltage V1 is applied to scan electrode SC1-scan electrode SCn.

Thus, a fourth discharge occurs in the discharge cells having undergone the weak discharge. This discharge is a second discharge between scan electrode SCi as a cathode and data electrode Dk as an anode, and is a weak discharge.

This weak discharge discharges the excess part of the wall voltage on scan electrode SCi, the wall voltage on sustain electrode SUi, and the wall voltage on data electrode Dk. The wall voltages are adjusted so as to be suitable for the address operation. Thus, the erasing operation in subfield SF1 is completed.

Next, subfield SF2 in the first field is described.

Subfield SF2 in the first field is a second subfield.

As shown in FIG. 11, in the address period of subfield SF2 in the first field, similarly to the address period of subfield SF1 in the first field, voltage 0 (V) is applied to data electrode D1-data electrode Dm, voltage Ve is applied to sustain electrode SU1-sustain electrode SUn, and voltage Vc is applied to scan electrode SC1-scan electrode SCn.

Next, a negative scan pulse at voltage Va is applied to scan electrode SCn in the n-th line, which undergoes an address operation first. Further, an address pulse at positive voltage Vd is applied to data electrode Dk of a discharge cell to be lit in the n-th line among data electrode D1-data electrode Dm.

At this time, similarly to the first exemplary embodiment, voltage Va is set so as to satisfy (Condition 1) and (Condition 2).

Thus, an address discharge occurs between data electrode Dk and scan electrode SCn and between sustain electrode SUn and scan electrode SCn. Positive wall voltage accumulates on scan electrode SCn, and negative wall voltage accumulates on sustain electrode SUn. Negative wall voltage also accumulates on data electrode Dk. In this manner, an address operation is performed so as to cause an address discharge in the discharge cells to be lit in the n-th line and accumulate wall voltages on the respective electrodes.

Thereafter, an address operation is performed in the discharge cells in the (n−1)-th line, the discharge cells in the (n−2)-th line, . . . , the discharge cells in the second line, and the discharge cells in the first line in this order.

Next, a description is provided for the sustain period of subfield SF2 in this exemplary embodiment.

In the sustain period of subfield SF2, voltage Vd is applied to all data electrode D1-data electrode Dm.

Similarly to the sustain period of subfield SF1, sustain pulses equal in number to the luminance weight multiplied by the predetermined luminance magnification are applied alternately to scan electrode SC1-scan electrode SCn and sustain electrode SU1-sustain electrode SUn. Thereby, a sustain discharge is continuously caused in the discharge cells having undergone the address discharge in the address period.

Next, a description is provided for the erasing period of subfield SF2 in this exemplary embodiment.

In the erasing period of subfield SF2, subsequently to the sustain period, voltage Vd is applied to data electrode D1-data electrode Dm in all the discharge cells.

Next, an up-ramp waveform voltage gently rising from voltage 0 (V) toward voltage Vr is applied to scan electrode SC1-scan electrode SCn while voltage 0 (V) is applied to sustain electrode SU1-sustain electrode SUn.

While the up-ramp waveform voltage applied to scan electrode SC1-scan electrode SCn is rising above the discharge start voltage, a weak erasing discharge occurs in the discharge cells having undergone the sustain discharge in the sustain period of the subfield (the discharge cells having undergone the address discharge in the subfield where the sustain period is omitted). This weak discharge reduces the wall voltages on scan electrode SCi and sustain electrode SUi while the positive wall voltage is left on data electrode Dk, and thus erases unnecessary wall charge in the discharge cell.

After the voltage applied to scan electrode SC1-scan electrode SCn has reached voltage Vr, the voltage applied to scan electrode SC1-scan electrode SCn is lowered to voltage 0 (V).

Next, voltage 0 (V) is applied to all data electrode D1-data electrode Dm. While voltage 0 (V) is applied to sustain electrode SU1-sustain electrode SUn, a down-ramp waveform voltage gently falling from voltage 0 (V) to voltage V1 is applied to scan electrode SC1-scan electrode SCn. Thus, a second weak discharge occurs in the discharge cells having undergone the weak erasing discharge.

Thereafter, voltage Vd is applied to all data electrode D1-data electrode Dm, and a rectangular waveform voltage at voltage Vr is applied to scan electrode SC1-scan electrode SCn at the same time.

Thus, a third discharge occurs in the discharge cells having undergone the weak discharge.

Next, voltage 0 (V) is applied to all data electrode D1-data electrode Dm, voltage Ve is applied to sustain electrode SU1-sustain electrode SUn, and a down-ramp waveform voltage gently falling from voltage 0 (V) to voltage Vi is applied to scan electrode SC1-scan electrode SCn.

Thus, a fourth discharge occurs in the discharge cells having undergone the weak discharge.

The weak discharge discharges the excess part of the wall voltage on scan electrode SCi, the wall voltage on sustain electrode SUi, and the wall voltage on data electrode Dk. The wall voltages are adjusted so as to be suitable for the address operation. In this manner, the erasing operation in subfield SF2 is completed.

In this exemplary embodiment, similarly to the first exemplary embodiment, subfields occurring in the odd-numbered positions in a first field (subfield SF1, subfield SF3, subfield SF5, subfield SF7, and subfield SF9 in this exemplary embodiment) are first subfields. An address operation is performed in the discharge cells in the first line, the discharge cells in the second line, the discharge cells in the third line, . . . , the discharge cells in the (n−1)-th line, and the discharge cells in the n-th line in this order. Subfields occurring in the even-numbered positions (subfield SF2, subfield SF4, subfield SF6, subfield SF8, and subfield SF10 in this exemplary embodiment) are second subfields. An address operation is performed in the discharge cells in the n-th line, the discharge cells in the (n−1)-th line, the discharge cells in the (n−2)-th line, . . . , the discharge cells in the second line, and the discharge cells in the first line in this order.

In the sustain period and erasing period of each of subfield SF3 through subfield SF10 in the first field, the respective electrodes are applied with the driving voltage waveforms similar to those in the sustain period and the erasing period of subfield SF2 in the first field except for the number of sustain pulses.

Next, a description is provided for a second field in this exemplary embodiment with reference to FIG. 12.

As shown in FIG. 12, subfields occurring in the odd-numbered positions in a second field (subfield SF1, subfield SF3, subfield SF5, subfield SF7, and subfield SF9 in this exemplary embodiment) are second subfields. Therefore, in the address periods, an address operation is performed in the discharge cells in the n-th line, the discharge cells in the (n−1)-th line, the discharge cells in the (n−2)-th line, . . . , the discharge cells in the second line, and the discharge cells in the first line in this order.

Subfields occurring in the even-numbered positions in the second field (subfield SF2, subfield SF4, subfield SF6, subfield SF8, and subfield SF10 in this exemplary embodiment) are first subfields. Therefore, in the address periods, an address operation is performed in the discharge cells in the first line, the discharge cells in the second line, the discharge cells in the third line, . . . , the discharge cells in the (n−1)-th line, and the discharge cells in the n-th line in this order.

In the address periods of the respective subfields in the second field, the respective electrodes are applied with the driving voltages similar to those in the address periods of the respective subfields in the first field except for the order of address operations in the first field.

In the sustain periods and the erasing periods of the respective subfields in the second field, the respective electrodes are applied with the driving voltage waveforms similar to those in the sustain periods and the erasing periods of the respective subfields in the first field. That is, in the sustain period and the erasing period of subfield SF1 in the second field, the respective electrodes are applied with the driving voltage waveforms similar to those in the sustain period and the erasing period of subfield SF1 in the first field. In the sustain period and the erasing period of each of subfield SF2 through subfield SF10 in the second field, the respective electrodes are applied with the driving voltage waveforms similar to those in the sustain period and the erasing period of subfield SF2 in the first field.

Also in this exemplary embodiment, similarly to the first exemplary embodiment, an image is displayed on panel 10 such that a first field and a second field are generated so as to be repeated alternately.

In this exemplary embodiment, in the sustain periods of subfields SF1 in both of a first field and a second field, the voltage applied to data electrode

Dp+1 of a discharge cell applied with the green phosphor (e.g. data electrode D2, data electrode D5, and data electrode D8) is set to voltage 0 (V). This voltage is lower than voltage Vd, which is applied to data electrode Dp of a discharge cell applied with the red phosphor (e.g. data electrode D1, data electrode D4, and data electrode D7) and data electrode Dp+2 of a discharge cell applied with the blue phosphor (e.g. data electrode D3, data electrode D6, and data electrode D9).

In this exemplary embodiment, this setting extends the set ranges (set margins) of voltage Va of the scan pulse applied to scan electrodes 22 in the address periods. Hereinafter, the reason is described.

As described above, discharge start voltage VFsd and discharge start voltage VFds in a discharge cell applied with the green phosphor tend to be higher than discharge start voltage VFsd and discharge start voltage VFds in a discharge cell applied with the red phosphor and a discharge cell applied with the blue phosphor. The set ranges of voltage Va satisfying the above (Condition 1) and (Condition 2) depend on discharge start voltage VFsd and discharge start voltage VFds. For this reason, in a discharge cell applied with the green phosphor, the set range of voltage Va of the scan pulse moves (shifts) to the relatively higher voltage side.

In addition, because the charging characteristic of the green phosphor is a negative voltage, the wall voltage on data electrode 32 of a discharge cell applied with the green phosphor is substantially lower than the wall voltage on data electrodes 32 of a discharge cell applied with the red phosphor and a discharge cell applied with the blue phosphor. This (moves) shifts the set range of voltage Va of a discharge cell applied with the green phosphor to the much higher voltage side.

The voltage value of voltage Va of the scan pulse in the plasma display apparatus needs to be set within the extent common to the following all set ranges based on (Condition 1) and (Condition 2): the set range of scan pulse voltage Va in a discharge cell applied with the red phosphor; the set range of scan pulse voltage Va in a discharge cell applied with the green phosphor; and the set range of scan pulse voltage Va in a discharge cell applied with the blue phosphor.

Thus, for instance, when the set range of scan pulse voltage Va in a discharge cell applied with the green phosphor moves (shifts) to the higher voltage side than the discharge cells of the other two colors, the set ranges (set margins) of scan pulse voltage Va are relatively narrowed.

Therefore, if the set range of scan pulse voltage Va in a discharge cell applied with the green phosphor that is based on (Condition 1) and (Condition 2) can be moved (shifted) to the lower voltage side, the set ranges of scan pulse voltage Va of discharge cells of the respective colors can fit in a relatively common extent and the set ranges (set margins) of scan pulse voltage Va can be relatively extended.

In this exemplary embodiment, the voltage applied to data electrode Dp+1 of a discharge cell applied with the green phosphor in the sustain period of subfield SF1 is set to voltage 0 (V). This voltage is lower than voltage Vd, which is applied to data electrodes 32 (data electrode Dp and data electrode Dp+2) of discharge cells of the other two colors. This setting can move (shift) the set range of scan pulse voltage Va in a discharge cell applied with the green phosphor to the lower voltage side. Thus, the set ranges of scan pulse voltage Va in discharge cells of the respective colors can fit in a relatively common extent and the set ranges (set margins) of scan pulse voltage Va can be relatively extended. The inventor of the present invention has experimentally verified the following fact. The set ranges of scan pulse voltage Va can be extended by a voltage substantially equal to voltage Vd (e.g. 60 (V)) by setting the voltage applied to data electrode Dp+1 of a discharge cell applied with the green phosphor to 0 (V) in the sustain period of subfield SF1.

Further, in this exemplary embodiment, as described above, none of an initializing discharge, an address discharge, a sustain discharge, and an erasing discharge are caused in a discharge cell displaying black (gradation value “0”). Thus, in a discharge cell displaying black, priming particles tend to be less sufficient, and the discharge start voltages tend to be relatively higher than in a discharge cell displaying a gradation value except black (a gradation value greater than gradation value “0”).

Therefore, in a discharge cell displaying black, the set range of voltage Va satisfying (Condition 1) and (Condition 2) tends to move (shift) to the higher voltage side than in a discharge cell displaying a gradation value except black (a gradation value greater than gradation value “0”).

For instance, suppose that the voltage applied to data electrode 32 of a discharge cell displaying black can be set lower than voltage Vd, which is applied to the data electrode of a discharge cell displaying a gradation value except black. Then, the set range of voltage Va satisfying (Condition 1) and (Condition 2) in the discharge cell displaying black is moved (shifted) to the lower voltage side, so that the set ranges (set margins) of voltage Va can be relatively extended.

As shown by these results, when black is displayed, it is preferable to set the voltage applied to data electrode Dp+1 of a discharge cell applied with the green phosphor lower than voltage Vd, which is applied to data electrodes 32 of discharge cells of the other two colors (data electrode Dp and data electrode Dp+2).

In this exemplary embodiment, coding is set such that moving image false contours are minimized. Coding is a combination of light emission and no light emission in each subfield set for display of each gradation value. The moving image false contour is a phenomenon such that, in display of a moving image on panel 10, the user views a false contour that is not present in the actual image.

A technique about coding for suppressing moving image false contours is disclosed in Japanese Patent Unexamined Publication No. 2008-197430, for example. In this exemplary embodiment, in order to suppress moving image false contours, coding is set such that, in display of each gradation, a subfield having a relatively light luminance weight is chosen among the subfields where a discharge cell is lit.

Thus, in the plasma display apparatus of this exemplary embodiment, the discharge cell is lit in the subfield having the lighter luminance weight with the higher probability. Further, when a moving image is displayed on panel 10, a dark gradation value close to black is displayed in a discharge cell displaying black with a high probability before and after (temporally) the display of black. This relatively increases the probability that the discharge cell is lit in subfield SF1 having the lightest luminance weight.

Therefore, in this exemplary embodiment, the voltage applied to data electrode Dp+1 of a discharge cell applied with the green phosphor in the sustain period of subfield SF1, i.e. the subfield having the lightest luminance weight, is set to 0 (V). This voltage is lower than voltage Vd, which is applied to data electrode Dp+1 in the sustain period of each of subfield SF2 through subfield SF10 and applied to data electrodes 32 of discharge cells of the other two colors (data electrode Dp and data electrode Dp+2) in the sustain period of each of subfield SF1 through subfield SF10.

Thus, the set ranges of scan pulse voltage Va in the discharge cells of the respective colors fit in a relatively common extent and the set ranges (set margins) of scan pulse voltage Va can be relatively extended.

However, in a discharge cell displaying a relatively high gradation value, the set range of voltage Va in subfield SF1 move (shift) to the lower voltage side. Thus, in a discharge cell emitting light at a high luminance, discharge tends to be unstable in subfield SF1. However, in a discharge cell displaying a relatively high gradation value and emitting light at a high luminance, the rate of emission luminance of subfield SF1 in the gradation value is relatively low. Therefore, in such a discharge cell, even occurrence of a false discharge in subfield SF1 poses substantially no problem.

In this exemplary embodiment, in the erasing periods, a first discharge between scan electrode SCi as an anode and sustain electrode SUi as a cathode (a first discharge) occurs. Thereafter, a first discharge between scan electrode SCi as a cathode and data electrode Dk as an anode (a second discharge) occurs. Thereafter, a second discharge between scan electrode SCi as an anode and sustain electrode SUi as a cathode (a third discharge) occurs. Thereafter, a second discharge between scan electrode SCi as a cathode and data electrode Dk as an anode (a fourth discharge) occurs.

In order to cause such a discharge as a weak discharge and minimize the light emission caused by the discharge, the following operations are performed in the erasing periods. While voltage 0 (V) is applied to sustain electrode SU1-sustain electrode SUn, an up-ramp waveform voltage, a down-ramp waveform voltage, and a positive rectangular waveform voltage are applied to scan electrode SC1-scan electrode SCn in this order. Thereafter, while voltage Ve higher than voltage 0 (V) is applied to sustain electrode SU1-sustain electrode SUn, a down-ramp waveform voltage is applied to scan electrode SC1-scan electrode SCn.

In this manner, in the erasing periods, even without a strong discharge, repeating a weak discharge in a plurality of times can accumulate sufficient wall voltages on the respective electrodes, thereby stabilizing the succeeding address discharge.

Next, a description is provided for the order in which scan pulses are applied to scan electrode SC1-scan electrode SCn in this exemplary embodiment.

The following charts show four subfields, i.e. subfield SF1 through subfield SF4, in each of a first field and a second field. These charts only show extractions of a part of a plurality of subfields constituting each field.

The following charts schematically show the order in which scan pulses are applied to scan electrode SC1-scan electrode SCn, using arrows.

In the following description, scan pulse generation circuit 70 includes four scan ICs (scan IC1, scan IC2, scan IC3, and scan IC4). Scan IC1 drives scan electrode SC1-scan electrode SC(n/4). Scan IC2 drives scan electrode SC(n/4+1)-scan electrode SC(n/2). Scan IC3 drives scan electrode SC(n/2+1)-scan electrode SC(3×n/4). Scan IC4 drives scan electrode SC(3×n/4+1)-scan electrode SCn. However, in this exemplary embodiment, the number of scan ICs included in scan pulse generation circuit 70 is not limited to four, and may be another number.

In this exemplary embodiment, an image is displayed on panel 10 such that a first field and a second field are generated alternately.

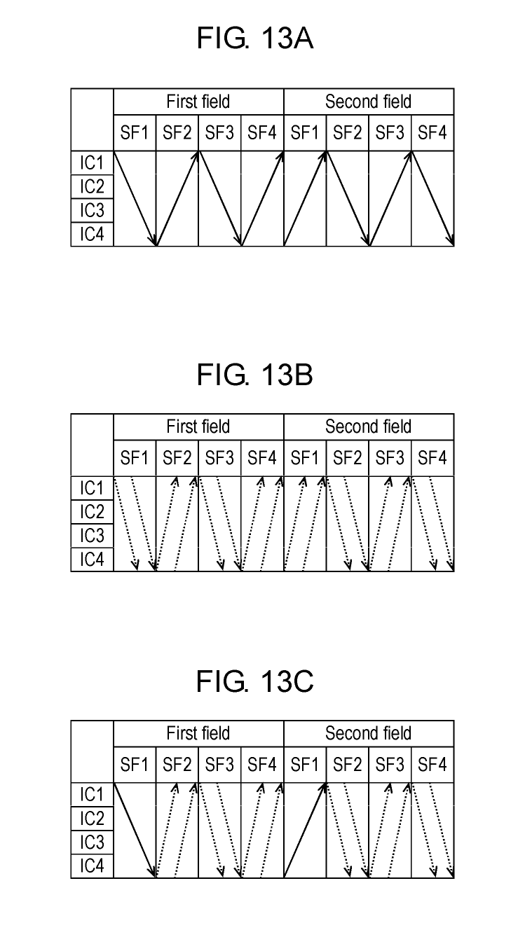

FIG. 13A is a chart schematically showing an example of order in which scan pulses are applied to scan electrode SC1-scan electrode SCn in panel 10 for use in the plasma display apparatus in accordance with the second exemplary embodiment of the present invention.

With reference to FIG. 13A, an arrow from the top left to the bottom right is shown in the area of subfield SF1 in the first field. This shows that a scan pulse is applied sequentially from scan electrode SC1 to scan electrode SCn formed in panel 10. That is, an address operation is performed in the discharge cells in the first line, the discharge cells in the second line, the discharge cells in the third line, . . . , the discharge cells in the (n−1)-th line, and the discharge cells in the n-th line in this order.

Hereinafter, applying a scan pulse sequentially from scan electrode SC1 to scan electrode SCn is referred to as “forward progressive scan”.

With reference to FIG. 13A, an arrow from the bottom left to the top right is shown in the area of subfield SF2 in the first field. This shows that a scan pulse is applied sequentially from scan electrode SCn to scan electrode SC1 formed in panel 10. That is, an address operation is performed in the discharge cells in the n-th line, the discharge cells in the (n−1)-th line, the discharge cells in the (n−2)-th line, . . . , the discharge cells in the second line, and the discharge cells in the first line in this order.

Hereinafter, applying a scan pulse sequentially from scan electrode SCn to scan electrode SC1 is referred to as “backward progressive scan”.

In the example of FIG. 13A, a “forward progressive scan” is performed in the following subfields: those occurring in the odd-numbered positions in the first field (e.g. subfield SF1, subfield SF3, subfield SF5, subfield SF7, and subfield SF9); and those occurring in the even-numbered positions in the second field (e.g. subfield SF2, subfield SF4, subfield SF6, subfield SF8, and subfield SF10). A “backward progressing scan” is performed in the subfields occurring in the even-numbered positions in the first field, and the subfields occurring in the odd-numbered positions in the second field.

In this exemplary embodiment, the advantage similar to the above can be obtained by the address operation performed as shown in FIG. 13A. That is, a white image can be displayed in the image display area of panel 10 immediately after the changeover from an entire black image signal to an entire white image signal.

FIG. 13B is a chart schematically showing another example of order in which scan pulses are applied to scan electrode SC1-scan electrode SCn in panel 10 for use in the plasma display apparatus in accordance with the second exemplary embodiment of the present invention.

With reference to FIG. 13B, two dotted arrows from the top left to the center bottom and from the center top to the right bottom are shown in the area of subfield SF1 in the first field. This shows that a scan pulse is applied to odd-numbered scan electrodes 22 first and to even-numbered scan electrodes 22 next sequentially from scan electrode SC1 to scan electrode SCn. That is, after an address operation has been performed in the discharge cells in the first line, the discharge cells in the third line, the discharge cells in the fifth line, . . . , the discharge cells in the (n−3)-th line, and the discharge cells in the (n−1)-th line, an address operation is performed in the discharge cells in the second line, the discharge cells in the fourth line, the discharge cells in the sixth line, . . . , the discharge cells in the (n−2)-th line, and the discharge cells in the n-th line in this order (n being an even number).

Hereinafter, applying a scan pulse to odd-numbered scan electrodes 22 first and to even-numbered scan electrodes 22 next sequentially from scan electrode SC1 to scan electrode SCn is referred to as “forward interlace scan”.

In the “forward interlace scan”, a scan pulse may be applied to even-numbered scan electrodes 22 first and to odd-numbered scan electrodes 22 next sequentially from scan electrode SC1 to scan electrode SCn.

With reference to FIG. 13B, two dotted arrows from the bottom left to the center top and from the center bottom to the right top are shown in the area of subfield SF2 in the first field. This shows that a scan pulse is applied to odd-numbered scan electrodes 22 first and to even-numbered scan electrodes 22 next sequentially from scan electrode SCn to scan electrode SC1. That is, after an address operation has been performed in the discharge cells in the (n−1)-th line, the discharge cells in the (n−3)-th line, . . . , the discharge cells in the fifth line, the discharge cells in the third line, and the discharge cells in the first line, an address operation is performed in the discharge cells in the n-th line, the discharge cells in the (n−2)-th line, . . . , the discharge cells in the sixth line, the discharge cells in the fourth line, and the discharge cells in the second line in this order (n being an even number).

Hereinafter, applying a scan pulse to odd-numbered scan electrodes 22 first and to even-numbered scan electrodes 22 next sequentially from scan electrode SCn to scan electrode SC1 is referred to as “backward interlace scan”.

In the “backward interlace scan”, a scan pulse may be applied to even-numbered scan electrodes 22 first and to odd-numbered scan electrodes 22 next sequentially from scan electrode SCn to scan electrode SC1.

In the example of FIG. 13B, a “forward interlace scan” is performed in the subfields occurring in the odd-numbered positions in the first field and in the subfields occurring in the even-numbered positions in the second field. A “backward interlace scan” is performed in the subfields occurring in the even-numbered positions in the first field and in the subfields occurring in the odd-numbered positions in the second field.

In this exemplary embodiment, the address operation shown in FIG. 13B may also be performed. The advantage similar to the above can be obtained also by the address operation performed as shown in FIG. 13B, for example. That is, a white image can be displayed in the image display area of panel 10 immediately after the changeover from an entire black image signal to an entire white image signal. Further, the electric power consumption in the plasma display apparatus can be advantageously reduced by performing the address operation shown in FIG. 13B in response to an image signal, for example.

FIG. 13C is a chart schematically showing still another example of order in which scan pulses are applied to scan electrode SC1-scan electrode SCn in panel 10 for use in the plasma display apparatus in accordance with the second exemplary embodiment of the present invention.

In the example of FIG. 13C, scan pulses are applied in the following manner. A “forward progressive scan” is performed in subfield SF1 in the first field, and a “backward progressive scan” is performed in subfield SF1 in the second field. A “backward interlace scan” is performed in the subfields occurring in the even-numbered positions in the first field and the subfields occurring in the odd-numbered positions in the second field (except for subfield SF1). A “forward interlace scan” is performed in the subfields occurring in the odd-numbered positions in the first field (except for subfield SF1) and subfields occurring in the even-numbered positions in the second field.

In this exemplary embodiment, the address operation shown in FIG. 13C may also be performed. The advantage similar to the above can be obtained also by the address operation performed as shown in FIG. 13C, for example. That is, a white image can be displayed in the image display area of panel 10 immediately after the changeover from an entire black image signal to an entire white image signal. Further, the electric power consumption in the plasma display apparatus can be advantageously reduced by performing the address operation shown in FIG. 13C in response to an image signal, for example.

Next, a description is provided for examples where an address operation is performed on scan electrode SC1-scan electrode SCn divided into two scan electrode groups. In the following description, scan electrode SC1-scan electrode SCq (q=n/2, for example) driven by scan IC1 and scan IC2 form a first scan electrode group, and scan electrode SC(q+1)-scan electrode SCn driven by scan IC3 and scan IC4 form a second scan electrode group.

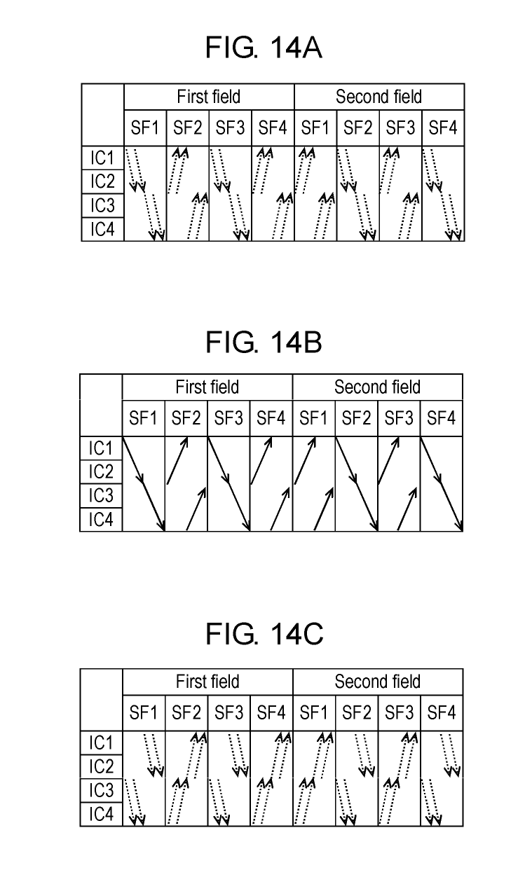

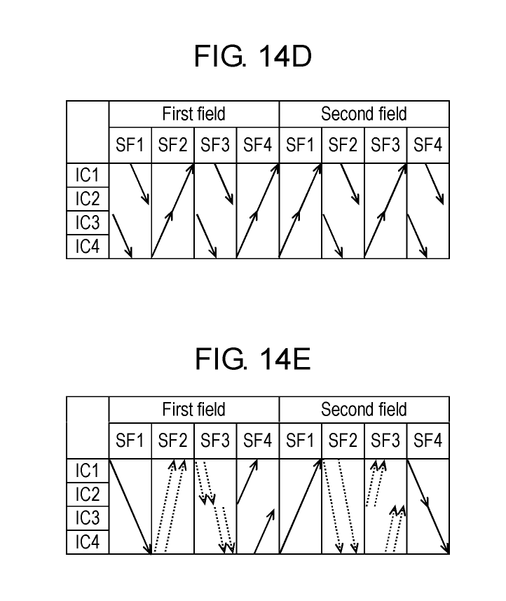

FIG. 14A is a chart schematically showing yet another example of order in which scan pulses are applied to scan electrode SC1-scan electrode SCn in panel 10 for use in the plasma display apparatus in accordance with the second exemplary embodiment of the present invention.

In the example of FIG. 14A, scan pulses are applied in the following manner. A “forward interlace scan” is performed on the first scan electrode group first and on the second scan electrode group next in the subfields occurring in the odd-numbered positions in the first field and the subfields occurring in the even-numbered positions in the second field. A “backward interlace scan” is performed on the first scan electrode group first and on the second scan electrode group next in the subfields occurring in the even-numbered positions in the first field and the subfields occurring in the odd-numbered positions in the second field.

FIG. 14B is a chart schematically showing still another example of order in which scan pulses are applied to scan electrode SC1-scan electrode SCn in panel 10 for use in the plasma display apparatus in accordance with the second exemplary embodiment of the present invention.

In the example of FIG. 14B, scan pulses are applied in the following manner. A “forward progressive scan” is performed on the first scan electrode group first and on the second scan electrode group next in subfields occurring in the odd-numbered positions in the first field and subfields occurring in the even-numbered positions in the second field. A “backward progressive scan” is performed on the first scan electrode group first and on the second scan electrode group next in the subfields occurring in the even-numbered positions in the first field and the subfields occurring in the odd-numbered positions in the second field.

FIG. 14C is a chart schematically showing yet another example of order in which scan pulses are applied to scan electrode SC1-scan electrode SCn in panel 10 for use in the plasma display apparatus in accordance with the second exemplary embodiment of the present invention.

In the example of FIG. 14C, scan pulses are applied in the following manner. A “forward interlace scan” is performed on the second scan electrode group first and on the first scan electrode group next in the subfields occurring in the odd-numbered positions in the first field and the subfields occurring in the even-numbered positions in the second field. A “backward interlace scan” is performed on the second scan electrode group first and on the first scan electrode group next in the subfields occurring in the even-numbered positions in the first field and the subfields occurring in the odd-numbered positions in the second field.

FIG. 14D is a chart schematically showing still another example of order in which scan pulses are applied to scan electrode SC1-scan electrode SCn in panel 10 for use in the plasma display apparatus in accordance with the second exemplary embodiment of the present invention.

In the example of FIG. 14D, scan pulses are applied in the following manner. A “forward progressive scan” is performed on the second scan electrode group first and on the first scan electrode group next in the subfields occurring in the odd-numbered positions in the first field and the subfields occurring in the even-numbered positions in the second field. A “backward progressive scan” is performed on the second scan electrode group first and on the first scan electrode group next in the subfields occurring in the even-numbered positions in the first field and the subfields occurring in the odd-numbered positions in the second field.

In this exemplary embodiment, the advantage similar to the above can be obtained also by performing the address operations shown in FIG. 14A through FIG. 14D. That is, a white image can be displayed in the image display area of panel 10 immediately after the changeover from an entire black image signal to an entire white image signal.

Further, in the address operations shown in these charts, an address operation can be performed on either of the first electrode group and the second electrode group with temporal priority. For example, in the address operations shown in FIG. 14A and FIG. 14B, an address operation can be performed on the first electrode group with temporal priority. In the address operations shown in FIG. 14C and FIG. 14D, an address operation can be performed on the second electrode group with temporal priority.

In this exemplary embodiment, the address operations shown in FIG. 13A through FIG. 13C and FIG. 14A through FIG. 14D can be performed in combination.

FIG. 14E is a chart schematically showing yet another example of order in which scan pulses are applied to scan electrode SC1-scan electrode SCn in panel 10 for use in the plasma display apparatus in accordance with the second exemplary embodiment of the present invention.

In the example of FIG. 14E, scan pulses are applied in the first field in the following manner. A “forward progressive scan” is performed in subfield SF1 and a “backward interlace scan” is performed in subfield SF2. A “forward interlace scan” is performed on the first scan electrode group first and on the second scan electrode group next in subfield SF3. A “backward progressive scan” is performed on the first scan electrode group first and on the second scan electrode group next in subfield SF4. Scan pulses are applied in the second field in the following manner. A “backward progressive scan” is performed in subfield SF1 and a “forward interlace scan” is performed in subfield SF2. A “backward interlace scan” is performed on the first scan electrode group first and on the second scan electrode group next in subfield SF3. A “forward progressive scan” is performed on the first scan electrode group first and on the second scan electrode group next in subfield SF4.

In this manner, the above various address operations may be combined. Also by such address operations, the advantage similar to the above can be obtained. That is, a white image can be displayed in the image display area of panel 10 immediately after the changeover from an entire black image signal to an entire white image signal.

Next, a description is provided for examples where an address operation is performed on scan electrode SC1-scan electrode SCn divided into four scan electrode groups. In the following description, scan electrodes 22 driven by scan IC1 (e.g. scan electrode SC1-scan electrode SC(n/4)) form a first scan electrode group. Scan electrodes 22 driven by scan IC2 (e.g. SC(n/4+1)-scan electrode SC(n/2)) form a second scan electrode group. Scan electrodes 22 driven by scan IC3 (e.g. scan electrode SC(n/2+1)-scan electrode SC(3×n/4)) form a third scan electrode group. Scan electrodes 22 driven by scan IC4 (e.g. scan electrode SC(3×n/4+1)-scan electrode SCn) form a fourth scan electrode group.

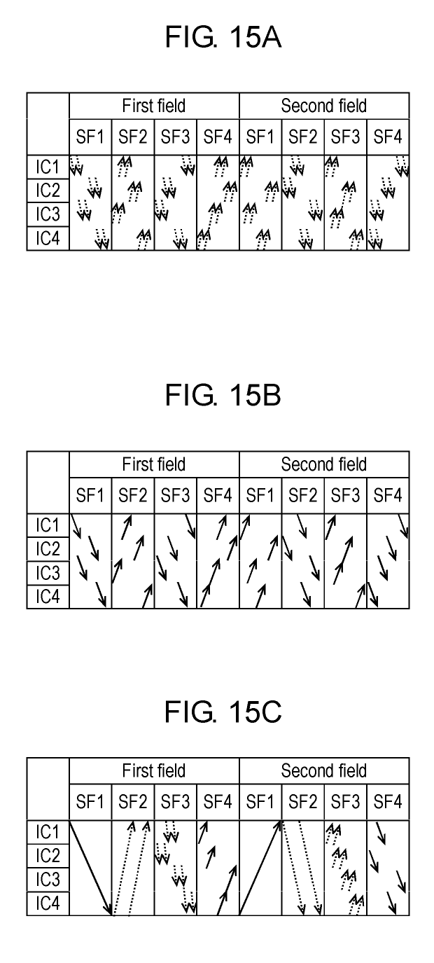

FIG. 15A is a chart schematically showing still another example of order in which scan pulses are applied to scan electrode SC1-scan electrode SCn in panel 10 for use in the plasma display apparatus in accordance with the second exemplary embodiment of the present invention.

In the example of FIG. 15A, scan pulses are applied in the following manner. A “forward interlace scan” is performed on the respective electrode groups in the subfields occurring in the odd-numbered positions in the first field and in the subfields occurring in the even-numbered positions in the second field. A “backward interlace scan” is performed on the respective electrode groups in the subfields occurring in the even-numbered positions in the first field and in the subfields occurring in the odd-numbered positions in the second field.

In the example of FIG. 15A, scan pulses are applied in the first field in the following manner. A “forward interlace scan” is performed on the first scan electrode group, the third scan electrode group, the second scan electrode group, and the fourth scan electrode group in this order in subfield SF1. A “backward interlace scan” is performed on the third scan electrode group, the first scan electrode group, the second scan electrode group, and the fourth scan electrode group in this order in subfield SF2. A “forward interlace scan” is performed on the third scan electrode group, the second scan electrode group, the fourth scan electrode group, and the first scan electrode group in this order in subfield SF3. A “backward interlace scan” is performed on the fourth scan electrode group, the third scan electrode group, the first scan electrode group, and the second scan electrode group in this order in subfield SF4. Scan pulses are applied in the second field in the following manner. A “backward interlace scan” is performed on the first scan electrode group, the third scan electrode group, the fourth scan electrode group, and the second scan electrode group in this order in subfield SF1. A “forward interlace scan” is performed on the second scan electrode group, the first scan electrode group, the fourth scan electrode group, and the third scan electrode group in this order in subfield SF2. A “backward interlace scan” is performed on the first scan electrode group, the third scan electrode group, the second scan electrode group, and the fourth scan electrode group in this order in subfield SF3. A “forward interlace scan” is performed on the fourth scan electrode group, the third scan electrode group, the second scan electrode group, and the first scan electrode group in this order in subfield SF4.

FIG. 15B is a chart schematically showing yet another example of order in which scan pulses are applied to scan electrode SC1-scan electrode SCn in panel 10 for use in the plasma display apparatus in accordance with the second exemplary embodiment of the present invention.

In the example of FIG. 15B, scan pulses are applied in the following manner. A “forward progressive scan” is performed on the respective electrode groups in the subfields occurring in the odd-numbered positions in the first field and in the subfields occurring in the even-numbered positions in the second field. A “backward progressive scan” is performed on the respective electrode groups in the subfields occurring in the even-numbered positions in the first field and in the subfields occurring in the odd-numbered positions in the second field.

In the example of FIG. 15B, scan pulses are applied in the first field in the following manner. A “forward progressive scan” is performed on the first scan electrode group, the third scan electrode group, the second scan electrode group, and the fourth scan electrode group in this order in subfield SF1. A “backward progressive scan” is performed on the third scan electrode group, the first scan electrode group, the second scan electrode group, and the fourth scan electrode group in this order in subfield SF2. A “forward progressive scan” is performed on the third scan electrode group, the second scan electrode group, the fourth scan electrode group, and the first scan electrode group in this order in subfield SF3. A “backward progressive scan” is performed on the fourth scan electrode group, the third scan electrode group, the first scan electrode group, and the second scan electrode group in this order in subfield SF4. Scan pulses are applied in the second field in the following manner. A “backward progressive scan” is performed on the first scan electrode group, the third scan electrode group, the fourth scan electrode group, and the second scan electrode group in this order in subfield SF1. A “forward progressive scan” is performed on the second scan electrode group, the first scan electrode group, the fourth scan electrode group, and the third scan electrode group in this order in subfield SF2. A “backward progressive scan” is performed on the first scan electrode group, the third scan electrode group, the second scan electrode group, and the fourth scan electrode group in this order in subfield SF3. A “forward progressive scan” is performed on the fourth scan electrode group, the third scan electrode group, the second scan electrode group, and the first scan electrode group in this order in subfield SF4.

In this exemplary embodiment, also by performing the address operations shown in FIG. 15A and FIG. 15B, the advantage similar to the above can be obtained. That is, a white image can be displayed in the image display area of panel 10 immediately after the changeover from an entire black image signal to an entire white image signal.

Further, in the address operations shown in these charts, an address operation can be performed on any one of the first electrode group through the fourth electrode group with temporal priority.

In this exemplary embodiment, the address operations shown in FIG. 13A through FIG. 13C, FIG. 14A through FIG. 14D, and FIG. 15A and FIG. 15B can be performed in combination.

FIG. 15C is a chart schematically showing still another example of order in which scan pulses are applied to scan electrode SC1-scan electrode SCn in panel 10 for use in the plasma display apparatus in accordance with the second exemplary embodiment of the present invention.

In the example of FIG. 15C, scan pulses are applied in the first field in the following manner. A “forward progressive scan” is performed in subfield SF1, and a “backward interlace scan” is performed in subfield SF2. A “forward interlace scan” is performed on the second scan electrode group, the first scan electrode group, the third scan electrode group, and the fourth scan electrode group in this order in subfield SF3. A “backward progressive scan” is performed on the first scan electrode group, the second scan electrode group, the fourth scan electrode group, and the third scan electrode group in this order in subfield SF4. Scan pulses are applied in the second field in the following manner. A “backward progressive scan” is performed in subfield SF1, and a “forward interlace scan” is performed in subfield SF2. A “backward interlace scan” is performed on the first scan electrode group, the second scan electrode group, the third scan electrode group, and the fourth scan electrode group in this order in subfield SF3. A “forward progressive scan” is performed on the second scan electrode group, the first scan electrode group, the fourth scan electrode group, and the third scan electrode group in this order in subfield SF4.

In this manner, the above various address operations may be combined. Also by such address operations, the advantage similar to the above can be obtained. That is, a white image can be displayed in the image display area of panel 10 immediately after the changeover from an entire black image signal to an entire white image signal.

Next, a description is provided for examples where scan pulse generation circuit 70 includes eight scan ICs (scan IC1, scan IC2, scan IC3, scan IC4, scan IC5, scan IC6, scan IC7, and scan IC8) and these scan ICs, i.e. scan IC1 through scan IC8, drive the respective eighths of scan electrode SC1-scan electrode SCn sequentially from that in the upper position of panel 10.

In the following description, scan electrodes 22 driven by scan IC1 form a first scan electrode group, scan electrodes 22 driven by scan IC2 form a second scan electrode group, scan electrodes 22 driven by scan IC3 form a third scan electrode group, scan electrodes 22 driven by scan IC4 form a fourth scan electrode group, scan electrodes 22 driven by scan IC5 form a fifth scan electrode group, scan electrodes 22 driven by scan IC6 form a sixth scan electrode group, scan electrodes 22 driven by scan IC7 form a seventh scan electrode group, and scan electrodes 22 driven by scan IC8 form an eighth scan electrode group.

Concurrently while an address operation is performed on the first scan electrode group through the fourth scan electrode group, an address operation is performed on the fifth scan electrode group through the eighth scan electrode group.

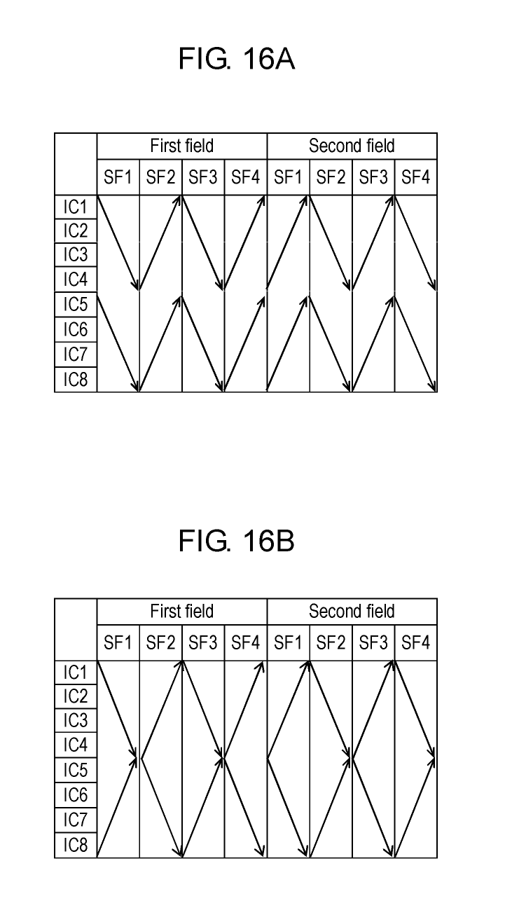

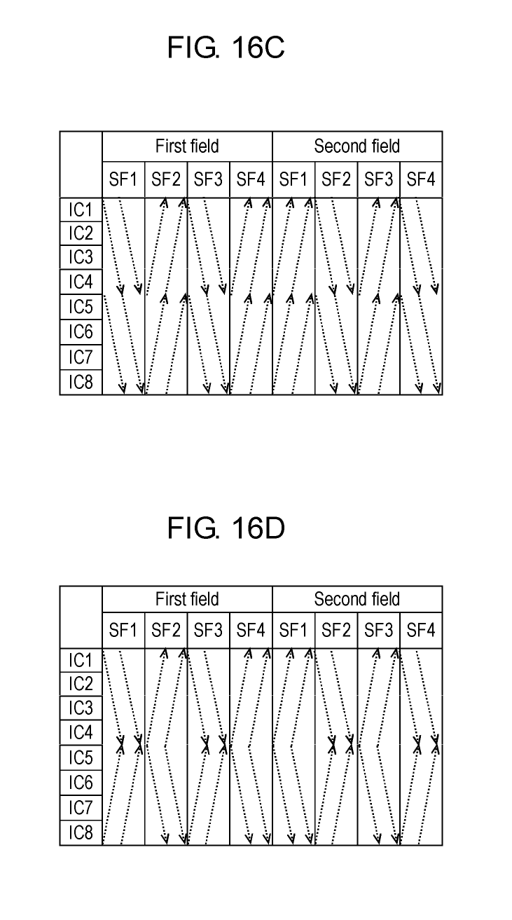

FIG. 16A is a chart schematically showing yet another example of order in which scan pulses are applied to scan electrode SC1-scan electrode SCn in panel 10 for use in the plasma display apparatus in accordance with the second exemplary embodiment of the present invention.

In the example of FIG. 16A, scan pulses are applied in the following manner. In the subfields occurring in the odd-numbered positions in the first field and the subfields occurring in the even-numbered positions in the second field, a “forward progressive scan” is performed on the first scan electrode group through the fourth scan electrode group in this order. Concurrently with this address operation, a “forward progressive scan” is performed on the fifth scan electrode group through the eighth scan electrode group in this order. In the subfields occurring in the even-numbered positions in the first field and in the subfields occurring in the odd-numbered positions in the second field, a “backward progressive scan” is performed on the fourth scan electrode group through the first scan electrode group in this order. Concurrently with this address operation, a “backward progressive scan” is performed on the eighth scan electrode group through the fifth scan electrode group in this order.

FIG. 16B is a chart schematically showing still another example of order in which scan pulses are applied to scan electrode SC1-scan electrode SCn in panel 10 for use in the plasma display apparatus in accordance with the second exemplary embodiment of the present invention.

In the example of FIG. 16B, scan pulses are applied in the following manner. In the subfields occurring in the odd-numbered positions in the first field and the subfields occurring in the even-numbered positions in the second field, a “forward progressive scan” is performed on the first scan electrode group through the fourth scan electrode group in this order. Concurrently with this address operation, a “backward progressive scan” is performed on the eighth scan electrode group through the fifth scan electrode group in this order. In the subfields occurring in the even-numbered positions in the first field and in the subfields occurring in the odd-numbered positions in the second field, a “backward progressive scan” is performed on the fourth scan electrode group through the first scan electrode group in this order. Concurrently with this address operation, a “forward progressive scan” is performed on the fifth scan electrode group through the eighth scan electrode group in this order.

FIG. 16C is a chart schematically showing yet another example of order in which scan pulses are applied to scan electrode SC1-scan electrode SCn in panel 10 for use in the plasma display apparatus in accordance with the second exemplary embodiment of the present invention.

In the example of FIG. 16C, scan pulses are applied in the following manner. In the subfields occurring in the odd-numbered positions in the first field and the subfields occurring in the even-numbered positions in the second field, a “forward interlace scan” is performed on the first scan electrode group through the fourth scan electrode group in this order. Concurrently with this address operation, a “forward interlace scan” is performed on the fifth scan electrode group through the eighth scan electrode group in this order. In the subfields occurring in the even-numbered positions in the first field and in the subfields occurring in the odd-numbered positions in the second field, a “backward interlace scan” is performed on the fourth scan electrode group through the first scan electrode group in this order. Concurrently with this address operation, a “backward interlace scan” is performed on the eighth scan electrode group through the fifth scan electrode group in this order.

FIG. 16D is a chart schematically showing still another example of order in which scan pulses are applied to scan electrode SC1-scan electrode SCn in panel 10 for use in the plasma display apparatus in accordance with the second exemplary embodiment of the present invention.

In the example of FIG. 16D, scan pulses are applied in the following manner. In the subfields occurring in the odd-numbered positions in the first field and the subfields occurring in the even-numbered positions in the second field, a “forward interlace scan” is performed on the first scan electrode group through the fourth scan electrode group in this order. Concurrently with this address operation, a “backward interlace scan” is performed on the eighth scan electrode group through the fifth scan electrode group in this order. In the subfields occurring in the even-numbered positions in the first field and in the subfields occurring in the odd-numbered positions in the second field, a “backward interlace scan” is performed on the fourth scan electrode group through the first scan electrode group in this order. Concurrently with the address operation, a “forward interlace scan” is performed on the fifth scan electrode group through the eighth scan electrode group in this order.

In this exemplary embodiment, also by performing the address operations shown in FIG. 16A, FIG. 16B, FIG. 16C and FIG. 16D, the advantage similar to the above can be obtained. That is, a white image can be displayed in the image display area of panel 10 immediately after the changeover from an entire black image signal to an entire white image signal.

The address operations shown in FIG. 13A through FIG. 16D are only examples in this exemplary embodiment of the present invention. In the present invention, the order in which scan pulses are applied to respective scan electrodes 22 is not limited to the order shown herein. The order in which scan pulses are applied to respective scan electrodes 22 may be set optimally for the characteristics of the panel and the specifications of the plasma display apparatus. Alternatively, the order may be adaptively changed in response to an image signal, for example. As described above, the advantage similar to the above can be obtained by changing the order of application of scan pulses to scan electrodes 22, in each subfield and in each field.

In the examples of the exemplary embodiments of the present invention, one field is formed of ten subfields. However, in the present invention, the number of subfields forming one field is not limited to the above number.

The driving voltage waveforms shown in FIG. 3, FIG. 4, FIG. 11, and FIG. 12 are only examples in the exemplary embodiments of the present invention. The present invention is not limited to these driving voltage waveforms. The circuit configurations shown in FIG. 8, FIG. 9, and FIG. 10 are only examples in the exemplary embodiments of the present invention. The present invention is not limited to these circuit configurations.

Each circuit block shown in the exemplary embodiments of the present invention may be formed as an electric circuit that performs each operation shown in the exemplary embodiments, or formed of a microcomputer, for example, programmed so as to perform the similar operations.

In the examples described in the exemplary embodiments, one pixel is formed of discharge cells of R, G, and B three colors. Also a panel that includes pixels, each formed of discharge cells of four or more colors, can use the configurations shown in the exemplary embodiments and provide the similar advantages.

The specific numerical values shown in the exemplary embodiments of the present invention are set based on the characteristics of panel 10 that has a 50-inch screen and 1024 display electrode pairs 24, and only show examples in the exemplary embodiments. The present invention is not limited to these numerical values. Preferably, each numerical value is set optimally for the characteristics of the panel, the specifications of the plasma display apparatus, or the like. Variations are allowed for each numerical value within the range in which the above advantages can be obtained. The number of subfields that form one field, the luminance weights of the respective subfields, or the like is not limited to the values shown in the exemplary embodiments of the present invention. The subfield structure may be switched in response to an image signal, for example.

### INDUSTRIAL APPLICABILITY

The present invention allows a stable address operation without a forced initializing operation and thus suppresses luminance of black level, thereby enhancing the contrast of a display image. Further, the present invention can display an image with a high image display quality by causing a stable address discharge when the display image switches from a black image to a normal image. Thus, the present invention is useful as a driving method for a panel and as a plasma display apparatus.

### REFERENCE MARKS IN THE DRAWINGS

10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35, 35R, 35G, 35B Phosphor layer
40 Plasma display apparatus
41 Image signal processing circuit
42 Data electrode driver circuit
43 Scan electrode driver circuit
44 Sustain electrode driver circuit
45 Timing generation circuit
50, 80 Sustain pulse generation circuit
51, 81 Power recovery circuit
60 Ramp waveform voltage generation circuit
61, 63 Miller integration circuit
70 Scan pulse generation circuit
85 Constant voltage generation circuit
Q55, Q56, Q59, Q69, Q71H1-Q71Hn, Q71L1-Q71Ln, Q72, Q83, Q84, Q86, Q87, Q91H1-Q91Hm, Q91L1-Q91Lm Switching element
E71 Electric power supply
Q61, Q63 Transistor
C61, C63 Capacitor
R61, R63 Resistor
IN61, IN63 Input terminal

1. A driving method for a plasma display panel,
the plasma display panel having a plurality of discharge cells, each of the discharge cells having a scan electrode, a sustain electrode, and a data electrode,
the driving method comprising:
forming one field, using a plurality of subfields, each of the subfields having an address period, a sustain period, and an erasing period;
in the address period, applying a scan pulse to the scan electrodes, and applying an address pulse to the data electrodes so as to selectively cause an address discharge in the discharge cells;
in the sustain period, applying sustain pulses corresponding in number to a luminance weight alternately to the scan electrodes and the sustain electrodes so as to cause a sustain discharge in the discharge cells having undergone the address discharge; and
in the erasing period, applying a predetermined voltage to the scan electrodes and the sustain electrodes so as to selectively cause an erasing discharge only in the discharge cells having undergone the address discharge in the immediately preceding address period,
wherein a voltage obtained by subtracting a voltage applied to the data electrode from a low-side voltage of the sustain pulses applied to the scan electrode in the sustain period is defined as a first voltage,
a voltage obtained by subtracting the voltage applied to the data electrode from a high-side voltage of the sustain pulses applied to the scan electrode in the sustain period is defined as a second voltage, and
a voltage obtained by subtracting a low-side voltage of the address pulse applied to the data electrode from a low-side voltage of the scan pulse applied to the scan electrode in the address period is defined as a third voltage,
based on the above definitions, a voltage applied to each electrode is set so as to satisfy conditions that
a voltage obtained by subtracting the third voltage from the first voltage is equal to or higher than a discharge start voltage of a discharge occurring between the data electrode as an anode and the scan electrode as a cathode, and
a voltage obtained by subtracting the third voltage from the second voltage is equal to or lower than a sum of the discharge start voltage of the discharge occurring between the data electrode as an anode and the scan electrode as a cathode and a discharge start voltage of a discharge occurring between the data electrode as a cathode and the scan electrode as an anode, and
the one field has a first subfield and a second subfield, and when the scan pulse is applied to each of the plurality of scan electrodes in the address period, the scan pulse is applied sequentially from one to an other one of the scan electrodes in the first subfield, and is applied sequentially from the other one to the one of the scan electrodes in the second subfield.

2. The driving method for the plasma display panel of claim 1, wherein the scan electrode is applied with a voltage ranging from the low-side voltage of the scan pulse to the high-side voltage of the sustain pulses, inclusive.

3. The driving method for the plasma display panel of claim 1, wherein an absolute value of the low-side voltage of the scan pulse is greater than an absolute value of the high-side voltage of the sustain pulses.

4. The driving method for the plasma display panel of claim 1, wherein
in the address period of the first subfield, the scan pulse is applied sequentially from the one of the scan electrodes disposed at one end of the plasma display panel to the other one of the scan electrodes disposed at an other end of the plasma display panel, and
in the address period of the second subfield, the scan pulse is applied sequentially from the other one of the scan electrodes disposed at the other end to the one of the scan electrodes disposed at the one end.

5. The driving method for the plasma display panel of claim 1, wherein the first subfield and the second subfield are generated alternately in the one field.

6. The driving method for the plasma display panel of claim 5, wherein
a first field and a second field are generated alternately,
in the first field, the subfield occurring first in the field is one of the first subfield and the second subfield, and
in the second field, the subfield occurring first in the field is a remainder of the first subfield and the second subfield.

7. The driving method for the plasma display panel of claim 1, wherein
the plasma display panel includes a discharge cell applied with a phosphor for emitting red light, a discharge cell applied with a phosphor for emitting green light, and a discharge cell applied with a phosphor for emitting blue light, and
in the sustain period of at least one subfield among the plurality of subfields forming one field, a voltage applied to the data electrode of the discharge cell applied with the phosphor for emitting green light is lower than a voltage applied to the data electrode of the discharge cell applied with the phosphor for emitting red light and a voltage applied to the data electrode of the discharge cell applied with the phosphor for emitting blue light.

8. The driving method for the plasma display panel of claim 7, wherein
in the sustain period of a subfield having a lightest luminance weight, the voltage applied to the data electrode of the discharge cell applied with the phosphor for emitting green light is lower than the voltage applied to the data electrode of the discharge cell applied with the phosphor for emitting red light and the voltage applied to the data electrode of the discharge cell applied with the phosphor for emitting blue light.

9. The driving method for the plasma display panel of claim 8, wherein
the voltage applied to the data electrode of the discharge cell applied with the phosphor for emitting green light is lower in the sustain period of the subfield having the lightest luminance weight than in the sustain periods of the subfields except the subfield having the lightest luminance weight.

10. The driving method for the plasma display panel of claim 1, wherein
in the erasing period, a first discharge between the sustain electrode as a cathode and the scan electrode as an anode is caused,
thereafter, a first discharge between the scan electrode as a cathode and the data electrode as an anode is caused,
thereafter, a second discharge between the sustain electrode as a cathode and the scan electrode as an anode is caused, and
thereafter, a second discharge between the scan electrode as a cathode and the data electrode as an anode is caused.

11. The driving method for the plasma display panel of claim 10, wherein
in the erasing period, while a fourth voltage is applied to the sustain electrodes, an up-ramp waveform voltage, a down-ramp waveform voltage, and a positive rectangular waveform voltage are applied to the scan electrodes in this order, and,
thereafter, while a fifth voltage higher than the fourth voltage is applied to the sustain electrodes, a down-ramp waveform voltage is applied to the scan electrodes.

12. The driving method for the plasma display panel of claim 11, wherein at least one subfield is set in one field, and when the positive rectangular waveform voltage is applied to the scan electrodes in the erasing period of this at least one subfield, the voltage applied to the data electrode of the discharge cell applied with the phosphor for emitting green light is lower than the voltage applied to the data electrode of the discharge cell applied with the phosphor for emitting red light and the voltage applied to the data electrode of the discharge cell applied with the phosphor for emitting blue light.

13. A plasma display apparatus comprising:
a plasma display panel having a plurality of discharge cells, each of the discharge cells having a scan electrode, a sustain electrode, and a data electrode; and
a driver circuit for driving the plasma display panel and displaying an image on the plasma display panel,
wherein the driver circuit drives the plasma display panel in a manner such that
one field is formed of a plurality of subfields, each of the subfields having an address period, a sustain period, and an erasing period,
in the address period, a scan pulse is applied to the scan electrodes, and an address pulse is applied to the data electrodes so as to selectively cause an address discharge in the discharge cells,
in the sustain period, sustain pulses corresponding in number to a luminance weight are applied alternately to the scan electrodes and the sustain electrodes so as to cause a sustain discharge in the discharge cells having undergone the address discharge, and
in the erasing period, a predetermined voltage is applied to the scan electrodes and the sustain electrodes so as to selectively cause an erasing discharge only in the discharge cells having undergone the address discharge in the immediately preceding address period,
a voltage obtained by subtracting a voltage applied to the data electrode from a low-side voltage of the sustain pulses applied to the scan electrode in the sustain period is defined as a first voltage,
a voltage obtained by subtracting the voltage applied to the data electrode from a high-side voltage of the sustain pulses applied to the scan electrode in the sustain period is defined as a second voltage, and
a voltage obtained by subtracting a low-side voltage of the address pulse applied to the data electrode from a low-side voltage of the scan pulse applied to the scan electrode in the address period is defined as a third voltage,
based on the above definitions, a voltage applied to each electrode is set so as to satisfy conditions that
a voltage obtained by subtracting the third voltage from the first voltage is equal to or higher than a discharge start voltage of a discharge occurring between the data electrode as an anode and the scan electrode as a cathode, and
a voltage obtained by subtracting the third voltage from the second voltage is equal to or lower than a sum of the discharge start voltage of the discharge occurring between the data electrode as an anode and the scan electrode as a cathode and a discharge start voltage of a discharge occurring between the data electrode as a cathode and the scan electrode as an anode, and
the one field has a first subfield and a second subfield, and when the scan pulse is applied to each of the plurality of scan electrodes in the address period, the scan pulse is applied sequentially from one to an other one of the scan electrodes in the first subfield, and is applied sequentially from the other one to the one of the scan electrodes in the second subfield.
